(19) United States
(12) Patent Application Publication
(10) Pub. No.: US 2025/0205690 A1
(43) Pub. Date: Jun. 26, 2025

(54) A CHA TYPE ZEOLITE AND THE METHOD OF SYNTHESISING SAID ZEOLITE

(71) Applicant: Johnson Matthey Public Limited Company, London (GB)

(72) Inventors: Sanyuan YANG, Savannah, GA (US); Daniel GILLELAND, Savannah, GA (US); Logan SPELL, Savannah, GA (US); Alessandro TURRINA, Billingham Cleveland (GB)

(21) Appl. No.: 18/847,548

(22) PCT Filed: May 17, 2023
(86) PCT No.: PCT/GB2023/051296

§ 371 Date: Sep. 16, 2024

Related U.S. Application Data
(60) Provisional application No. 63/364,824, filed on May 17, 2022.
(60) Provisional application No. 63/384,812, filed on Nov. 23, 2022.

(51) Int. Cl. B01J 29/70; B01D 53/94; B01J 35/77; B01J 37/00; B01J 37/03; B01J 37/04; B01J 37/06; C01B 39/02; C01B 39/48; F01N 3/28

(52) U.S. Cl. CPC B01J 29/7015; B01D 53/9418; B01J 35/77; B01J 37/0018; B01J 37/009; B01J 37/031; B01J 37/04; B01J 37/06; C01B 39/026; C01B 39/48; B01D 2251/2062; B01D 2255/20761; B01D 2255/50; B01D 2257/404; B01D 2258/012; C01P 2002/60; C01P 2002/72; C01P 2002/74; C01P 2002/76; C01P 2004/03; F01N 3/2803; F01N 2370/04

(57) ABSTRACT

A hydrogen-form chabazite (CHA) zeolite having a SAR of from 8 to 35 with a ratio of the XRD peak intensity corresponding to [2 1 1] and [−1 1 1] reflection equal to or greater than 0.80. The CHA zeolite can be made by a method comprising: (i) forming a reaction gel comprising a precursor zeolite (e.g. FER), an organic structure directing agent (OSDA), sodium and/or potassium hydroxide and optionally a silica source, and (ii) heating the reaction gel to a temperature and for a duration suitable for the growth of the CHA zeolite. Suitable OSDAs for step (i) include N,N,N-trimethyl-1-adamantylammonium, N,N,N-dimethylethylcyclohexylam monium, trimethyl(cyclohexylmethyl) ammonium, tetraethylammonium, N-Ethyl-N,N-dimethylcyclohexanaminium, benzyltrimethyl ammonium, N,N,N-triethylcyclohexylammonium, N,N,N-trimethylcyclohexyl ammonium, N,N,N-diethylmethylcyclohexyl ammonium, trimethyl cyclohexyl ammonium, trimethyl phenyl ammonium and triethylmethyl ammonium.

### FIELD OF THE INVENTION

The present invention relates to a chabazite (CHA) zeolite. More particularly, the present invention relates to a hydrogen-form chabazite zeolite having a silica-alumina ratio (SAR) of from 8 to 35. The present invention also relates to a method for the manufacture of a chabazite zeolite, specifically a zeolite having an SAR of from 8 to 35. The present invention further relates to a catalyst article comprising a chabazite zeolite and a method for the treatment of an exhaust gas which comprises contacting an exhaust gas with a catalyst article comprising a chabazite zeolite.

### BACKGROUND OF THE INVENTION

Since the discovery of SSZ-13, a silica-rich CHA type zeolite in 1985 (U.S. Pat. No. 4,544,538), this zeolite has been extensively studied and produced at industrial scale notably as the key component of NH₃—SCR catalyst in NOx abatement applications. Meanwhile, various improvements related to SSZ-13 have been reported, for example, reducing crystal size for improvement in accessibility of the zeolite internal porous space for catalytic reactions (see U.S. Pat. Nos. 6,709,644 and 10,407,314), making larger crystals (U.S. Pat. No. 10,029,247) or crystals with reduced silanol defects (U.S. Pat. Nos. 10,407,314 and 10,953,390) for improvement of zeolite durability under harsh working conditions, and producing the zeolite with alternative OSDA for cost-effective manufacturing (U.S. Pat. Nos. 8,007,764 and 10,953,390).

The worldwide environmental regulations have become increasingly more stringent. The emission standards in developing countries are catching up with the higher standards required in developed countries. For these reasons, there remains an urgent call for further improvement or ever-better performance of CHA product particularly for use in NH₃—SCR applications.

When used as component material in catalyst preparation, the processability of a zeolite also bears significant consequences on the physical or mechanical properties of the end catalyst product. For example, it is often one of the key factors influencing the uniformity and physical strength of the wash coat layers, and the effect on backpressure. Thus, further improvement of processability is also needed.

To meet these challenges, the applicants have discovered a novel SSZ-13 type of CHA zeolite and the synthesis method to make the same, which have substantial advantages including processability improvement over the prior art. In addition, the inventors have discovered that the CHA zeolite of the present invention with a XRD peak intensity ratio as defined herein has low crystal lattice defects and high crystallinity.

### SUMMARY OF THE INVENTION

One aspect of the present disclosure is directed to a hydrogen-form chabazite (CHA) zeolite having SAR of from 8 to 35 with a ratio of the XRD peak intensity corresponding to [2 1 1] and [−1 1 1] reflection equal to or greater than 0.80.

Another aspect of the present disclosure is directed to a method for the manufacture of a chabazite (CHA) zeolite having an SAR of from 8 to 35, the method comprising:
(i) forming a reaction gel comprising a precursor zeolite, an organic structure directing agent (OSDA), sodium and/or potassium hydroxide and optionally a silica source, and
(ii) heating the reaction gel to a temperature and for a duration suitable for the growth of the CHA zeolite.

Another aspect of the present disclosure is directed to a catalyst article for the treatment of an exhaust gas, the catalyst article comprising the hydrogen-form CHA zeolite as described herein.

Another aspect of the present disclosure is directed to a method for the treatment of an exhaust gas, the method comprising contacting an exhaust gas with the catalyst article described herein.

### BRIEF DESCRIPTION OF THE DRAWINGS

FIG. 1 shows a powder X-ray diffraction (XRD) pattern and SEM images of the H-form CHA structure made in Example 1.

FIG. 2 shows a powder X-ray diffraction (XRD) pattern and SEM images of the H-form CHA structure made in Example 2.

FIG. 3 shows a powder X-ray diffraction (XRD) pattern and SEM images of the H-form CHA structure made in Example 3.

FIG. 4 shows a powder X-ray diffraction (XRD) pattern and SEM images of the H-form CHA structure made in Example 4.

FIG. 5 shows a powder X-ray diffraction (XRD) pattern and SEM images of the H-form CHA structure made in Example 5.

FIG. 6 shows a powder X-ray diffraction (XRD) pattern and SEM images of the H-form CHA structure made in Example 6.

FIG. 7 shows a powder X-ray diffraction (XRD) pattern and SEM images of the H-form CHA structure made in Example 7.

FIG. 8 shows a powder X-ray diffraction (XRD) pattern and SEM images of the H-form CHA structure made in Example 8.

FIG. 9 shows a powder X-ray diffraction (XRD) pattern and SEM images of the H-form CHA structure made in Example 9.

FIG. 10 shows a powder X-ray diffraction (XRD) pattern and SEM images of the H-form CHA structure made in Example 10.

FIG. 11 shows a powder X-ray diffraction (XRD) pattern and SEM images of the H-form CHA structure made in Example 11.

FIG. 12 shows a powder X-ray diffraction (XRD) pattern and SEM images of the H-form CHA structure made in Example 12.

FIG. 13 shows a powder X-ray diffraction (XRD) pattern and SEM images of the H-form CHA structure made in Example 13.

FIG. 14 shows a powder X-ray diffraction (XRD) pattern and SEM images of the H-form CHA structure made in Example 14.

FIG. 15 shows a powder X-ray diffraction (XRD) pattern and SEM images of the H-form CHA structure made in Example 15.

FIG. 16 shows a powder X-ray diffraction (XRD) pattern and SEM images of the H-form CHA structure made in Example 16.

FIG. 17 shows a powder X-ray diffraction (XRD) pattern and SEM images of the H-form CHA structure made in Example 17.

FIG. 18 shows a powder X-ray diffraction (XRD) pattern and SEM images of the H-form CHA structure made in Example 18.

FIG. 19 shows a powder X-ray diffraction (XRD) pattern and SEM images of the H-form CHA structure made in Example 19.

FIG. 19b shows a powder X-ray diffraction (XRD) pattern and SEM images of the H-form CHA structure made in Example 20.

FIG. 20 shows a powder X-ray diffraction (XRD) pattern and SEM images of the H-form CHA structure made in Comparative Example A.

FIG. 21 shows a powder X-ray diffraction (XRD) pattern and SEM images of the H-form CHA structure made in Comparative Example B.

FIG. 22 shows a powder X-ray diffraction (XRD) pattern and SEM images of the H-form CHA structure made in Comparative Example C.

FIG. 23 shows the NOx conversion for Example 1

FIG. 24 shows the N₂O made for Example 1

FIG. 25 shows the NOx conversion for reference CHA, CHA1

FIG. 26 shows the N₂O made for reference CHA, CHA1

FIG. 27 shows the NOx conversion for Example 2

FIG. 28 shows the N₂O made for Example 2

FIG. 29 shows the NOx conversion for reference CHA, CHA2

FIG. 30 shows the N₂O made for reference CHA, CHA2

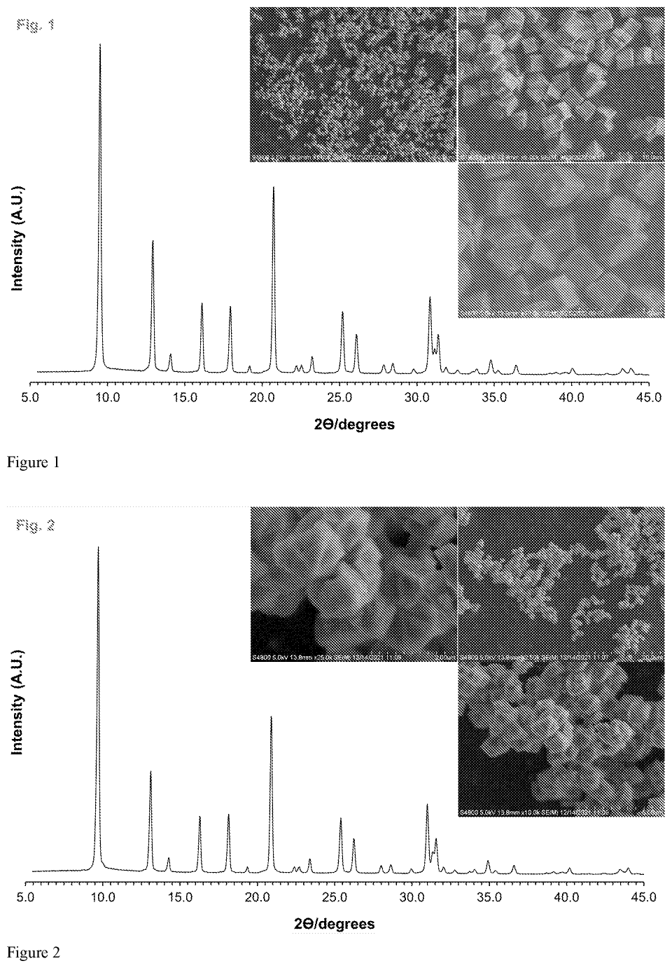

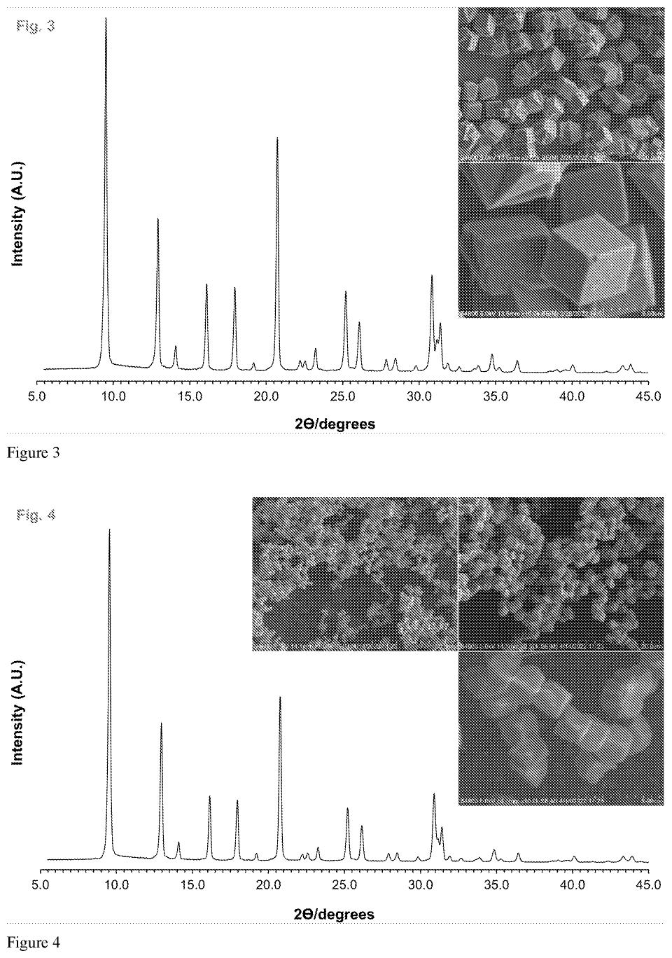

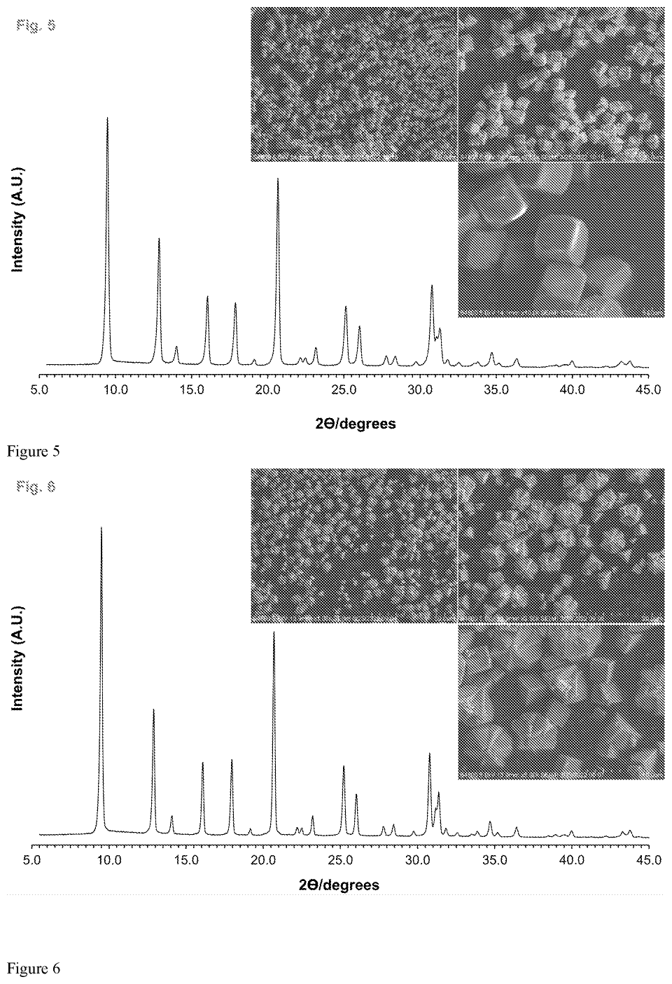

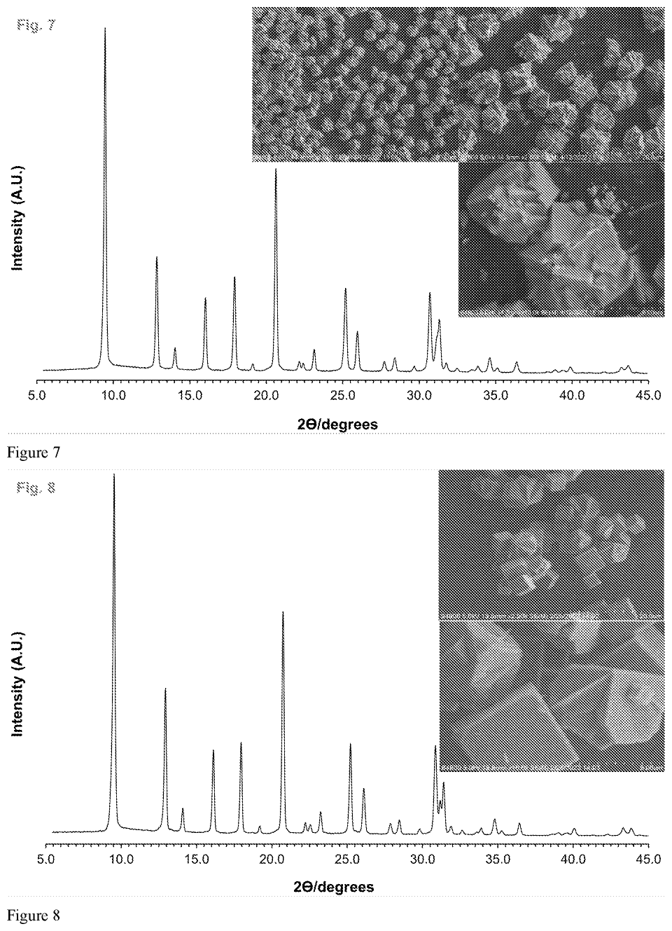

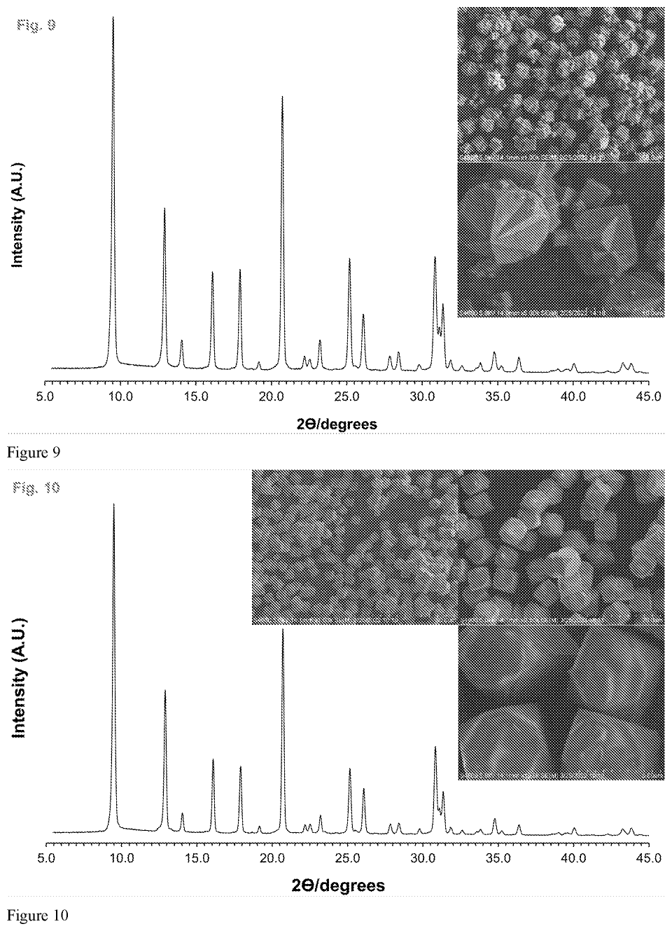

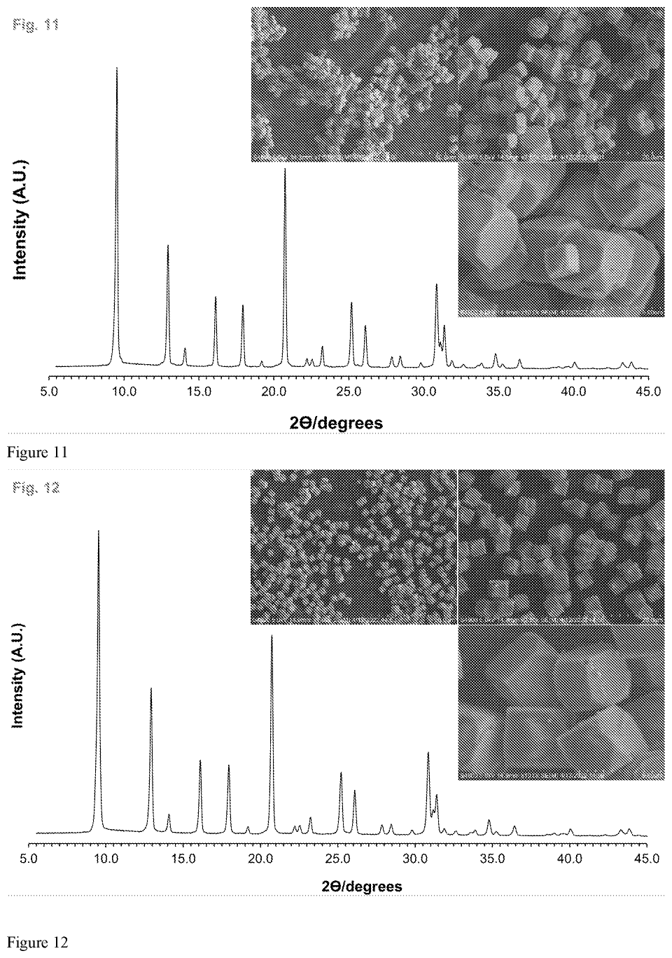

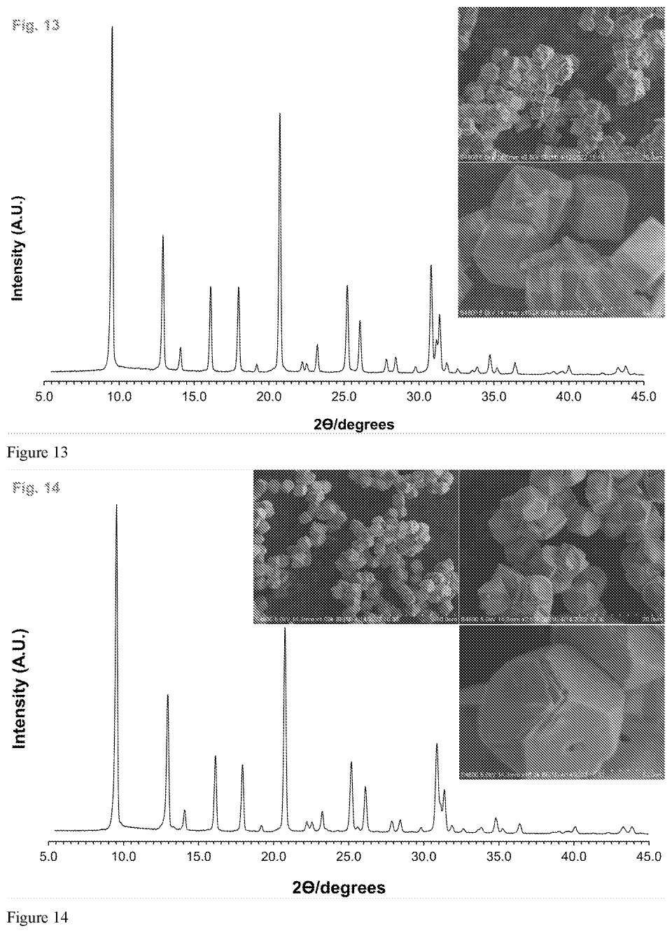

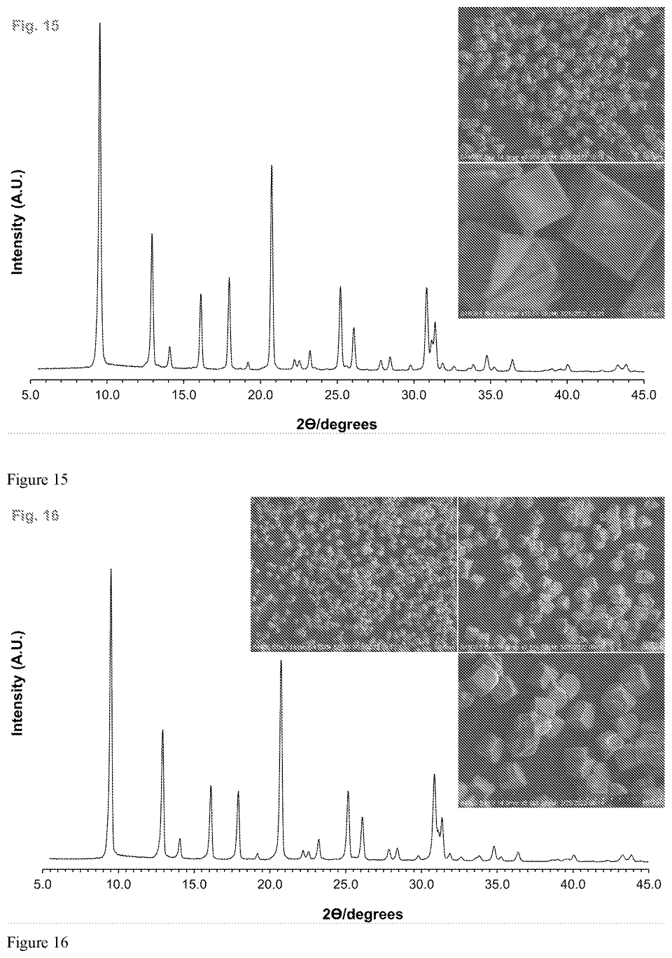

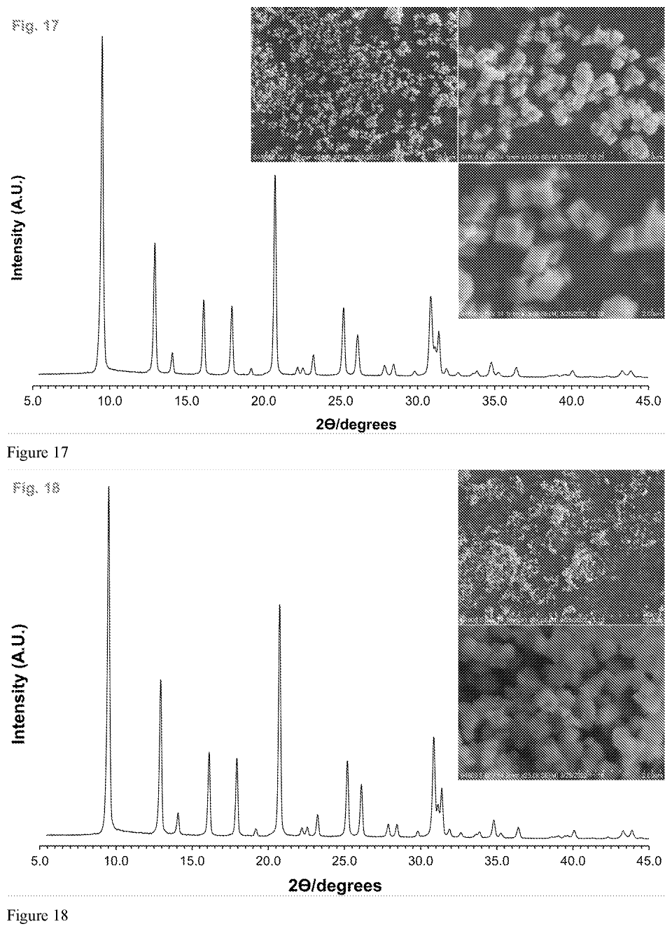

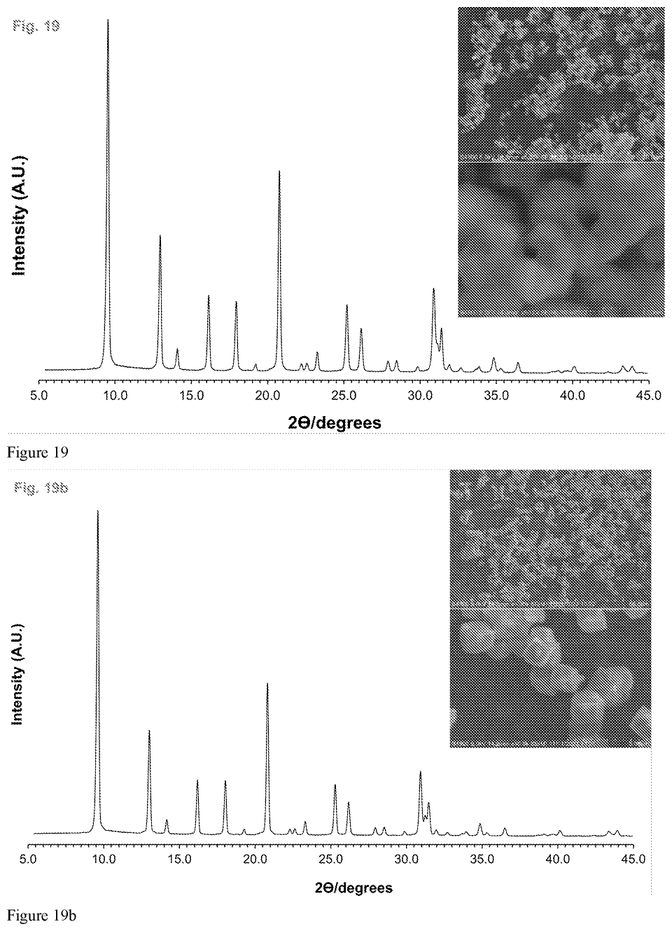

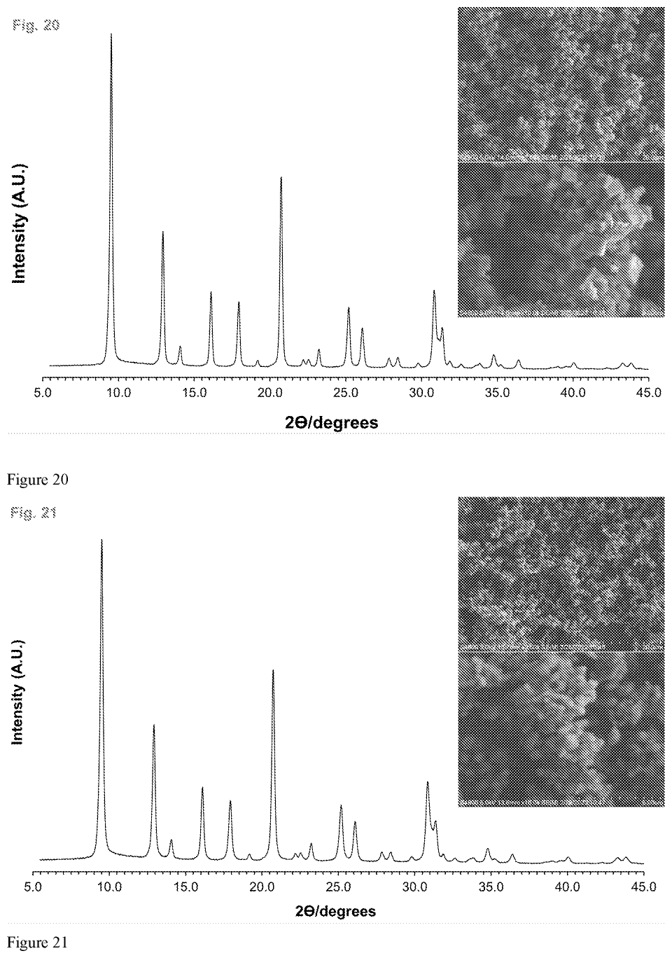

### DETAILED DESCRIPTION OF THE INVENTION

A first aspect of the present invention is directed to a hydrogen-form chabazite (CHA) zeolite having SAR of from 8 to 35 with a ratio of the XRD peak intensity corresponding to [2 1 1] and [−1 1 1] reflection equal to or greater than 0.80.

The present disclosure will now be described further. In the following passages, different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

Zeolites are structures formed from alumina and silica and the SAR determines the reactive sites within the zeolite structure. Small-pore zeolites, including CHA-type zeolites, possess pores that are constructed of eight tetrahedral atoms (Si⁴⁺ and Al³⁺), each time linked by a shared oxygen. These eight-member ring pores provide small molecules access to the intracrystalline void space, e.g., to NOₓ during car exhaust cleaning (NOₓ removal) or to methanol en route to its conversion into light olefins, while restricting larger molecule entrance and departure that is critical to overall catalyst performance. A CHA zeolite may also be referred to as a zeolite having a CHA framework structure as is known in the art.

The CHA zeolite according to the invention is a hydrogen-form (H-form) CHA zeolite. The term “H-form” of a CHA zeolite refers to a CHA zeolite with the framework charge substantially balanced by protons. In this form, the CHA zeolite generally contains a mixture of H⁺ and alkali and/or alkaline earth cations in the exchange sites. The H-form of a CHA zeolite can be ≥90%, ≥95%, ≥96%, ≥97%, ≥98%, or ≥99% (by weight) in H-form. The amount of the CHA zeolite in H-form can vary depending on the specific CHA zeolite batch and the method used to form the CHA zeolite.

In a preferred embodiment, the CHA zeolite according to the invention is free or substantially free from one or more of the following: fluorine, fluorine-containing compounds, fluorine ions, phosphorous, phosphorous containing compounds and phosphorous ions. Preferably, CHA zeolite according to the invention is free or substantially free from all of the following: fluorine, fluorine-containing compounds, fluorine ions, phosphorous, phosphorous containing compounds and phosphorous ions. By “substantially free from”, it is meant that the zeolite contains less than 0.1%, e.g. less than 0.08%, less than 0.05%, less than 0.03%, less than 0.02%, less than 0.01%, less than 0.005%, less than 0.001% (by weight based on the total weight of the zeolite) of the undesired components.

The H-form CHA zeolite of the present invention has a ratio of the XRD peak intensity corresponding to [2 1 1] and [−1 1 1] reflection equal to or greater than 0.80. In a preferred embodiment, the ratio is equal to or greater than 0.85, 0.9, 0.95, 1.0, 1.5. In a further embodiment, the ratio is in the range of 0.8 to 2.5, 0.85 to 2, 0.9 to 1.9, 1 to 1.8, or 1.1 to 1.7.

A person skilled in the art would use their common general knowledge to calculate the XRD peak intensity ratio of the [2 1 1] and [−1 1 1] reflections. As would be well understood, the X-ray diffraction data contains (2 theta) peaks in the range of 24.5 to 25.5 (±0.2 s-theta degrees), which correspond to the [2 1 1] reflection and (2 theta) peaks in the range of 15 to 17, which correspond to the [−1 1 1] reflection. The ratio of the XRD peak intensity corresponding to [2 1 1] and [−1 1 1] reflection is calculated by calculating the total peak height from the baseline to the top of the peak for the [2 1 1] and [−1 1 1] reflections, and then calculating the ratio of the peak heights for the [2 1 1]:[−1 1 1] reflections, i.e. by using the following equation:

$$ratio = \frac{peak height for [ 211 ] reflection}{peak height for [ - 111 ] reflection}$$

The XRD peak intensity according to the present invention was calculated using copper as the X-ray source. The peak intensity can be calculated using the CHA zeolite equilibrated to ambient conditions. For example, ambient conditions can be a temperature of from 18 to 25° C. and a humidity of up to 60%, e.g. up to 50%, up to 40% or up to 30%.

In one embodiment, the CHA zeolite of the present invention has a SAR of from 8 to 17 and a ratio of the XRD peak intensity corresponding to [2 1 1] and [−1 1 1] reflection equal to or greater than 0.95. In a further embodiment, the SAR can be from 8 to 17, 9 to 16, 10 to 15, 11 to 14, or 12 to 13 (e.g. when the ratio of the XRD peak intensity corresponding to [2 1 1] and [−1 1 1] reflection equal to or greater than 0.95). In a further embodiment, (e.g. when the SAR is from 8 to 17), the ratio of the XRD peak intensity corresponding to [2 1 1] and [−1 1 1] reflection is equal to or greater than 0.95, e.g. equal to or greater than 1, 1.05, 1.1, 1.15, 1.2, 1.25, 1.3, 1.35, 1.4, 1.45 or 1.5. In a further embodiment, (e.g. when the SAR is from 8 to 17), the ratio of the XRD peak intensity corresponding to [2 1 1] and [−1 1 1] reflection is in the range of 0.95 to 2.5, 1 to 2.25, 1.1 to 2, 1.2 to 1.9, 1.3 to 1.8, 1.4 to 1.7, or 1.5 to 1.6.

In one embodiment, the CHA zeolite of the present invention has a SAR of from 17 to 24 and a ratio of the XRD peak intensity corresponding to [2 1 1] and [−1 1 1] reflection equal to or greater than 0.85. In a further embodiment, the SAR can be from 17 to 24, 18 to 23, 19 to 22, or 20 to 21 (e.g. when the ratio of the XRD peak intensity corresponding to [2 1 1] and [−1 1 1] reflection equal to or greater than 0.85). In a further embodiment, (e.g. when the SAR is from 17 to 24), the ratio of the XRD peak intensity corresponding to [2 1 1] and [−1 1 1] reflection is equal to or greater than 0.85, e.g. equal to or greater than 0.9, 0.95, 1, 1.05, 1.1, 1.15, 1.2, 1.25, 1.3, 1.35, 1.4, 1.45 or 1.5. In a further embodiment, (e.g. when the SAR is from 17 to 24), the ratio of the XRD peak intensity corresponding to [2 1 1] and [−1 1 1] reflection is in the range of 0.85 to 2.5, 0.9 to 2.25, 0.95 to 2, 1 to 1.9, 1.1 to 1.8, 1.25 to 1.75, 1.4 to 1.7, or 1.5 to 1.6.

In one embodiment, the CHA zeolite of the present invention has a SAR of from 24 to 34 and a ratio of the XRD peak intensity corresponding to [2 1 1] and [−1 1 1] reflection equal to or greater than 0.80. In a further embodiment, the SAR can be from 25 to 33, 26 to 32, 27 to 31, or 28 to 30 (e.g. when the ratio of the XRD peak intensity corresponding to [2 1 1] and [−1 1 1] reflection equal to or greater than 0.80). In a further embodiment, (e.g. when the SAR is from 24 to 34), the ratio of the XRD peak intensity corresponding to [2 1 1] and [−1 1 1] reflection is equal to or greater than 0.80, e.g. equal to or greater than 0.85, 0.9, 0.95, 1, 1.05, 1.1, 1.15, 1.2, 1.25, 1.3, 1.35, 1.4, 1.45 or 1.5. In a further embodiment, (e.g. when the SAR is from 24 to 34), the ratio of the XRD peak intensity corresponding to [2 1 1] and [−1 1 1] reflection is in the range of 0.80 to 2.5, 0.85 to 2.25, 0.9 to 2, 0.95 to 1.9, 1 to 1.8, 1.25 to 1.75, 1.4 to 1.7, or 1.5 to 1.6.

Preferably, the CHA zeolite of the present invention has an SAR of at most 35, preferably at most 33, preferably at most 30, more preferably at most 28 and even more preferably at most 25. It is also preferred in some embodiments that the CHA zeolite has an SAR of at least 8 or at least 9. In some embodiments, it is preferred that the CHA zeolite has an SAR of from 8 to 35, 9 to 33, 10 to 30, 11 to 28, 12 to 25, 13 to 22, 14 to 21, 15 to 20, 16 to 19 or 17 to 18. In other embodiments, the SAR is preferably from 8 to 33, from 8 to 30, from 9 to 30, from 9 to 28, from 9 to 25, from 10 to 22 or from 10 to 20.

In a further embodiment, the CHA zeolite of the present invention has a SAR of between 16 and 35, preferably between 17 and 30, e.g. between 17 and 25 or between 17 and 23. In some embodiments, it is preferred that the CHA zeolite has a SAR of from 17 and 25, between 17.5 and 24, between 18 and 23 or between 19 and 22.

Alone or in combination with any of the desired features as described above, the invention can provide a CHA zeolite having a mesoporous surface area of less than 35 m2/g, preferably no greater 30 m²/g, more preferably no greater than 25 m²/g. In some embodiments, the CHA zeolite can have a mesoporous surface area of no greater than 24 m²/g, no greater than 22 m²/g, no greater than 21 m²/g, no greater than 20 m²/g, no greater than 19 m²/g, no greater than 18 m²/g, no greater than 17 m²/g, no greater than 16 m²/g, no greater than 15 m²/g, no greater than 14 m²/g, no greater than 12 m²/g or no greater than 10 m²/g. In certain embodiments, the CHA zeolite can a mesoporous surface area of 0-35 m²/g, 1-30 m²/g, 2-25 m²/g, or 3-24 m²/g, 4-22 m²/g, 5-20 m²/g, 6-18 m²/g, 7-17 m²/g, 8-15 m²/g or 9-12 m²/g. This unique combination of features has been achieved as a result of the unique synthetic methodology described herein. In particular, the present inventors have identified specific gel formulations which can enable the production of CHA zeolites with the desired SAR as described herein together with a mesoporous surface area of less than 35 m²/g.

Mesoporous surface area may be measured using any conventional technique in the art. For example, by measuring the Ar or N₂ adsorption isotherms on the activated samples at 87 or 77 K, respectively, according to the Brunauer-Emmett-Teller (BET) method. Prior to measurement the samples are heated under vacuum to remove physiosorbed water. The pore size distributions are measured by the nonlocal density functional theory (NLDFT). The mesopore surface area is calculated by the difference between the apparent BET and the micropore surface areas.

Alone or in combination with any of the desired features as described above, the present invention can provide a CHA zeolite having a BET surface area of 500-800 m²/g: preferably, 600-800 m²/g: or more preferably, 650-800 m²/g.

Alone, or in combination with any of the desired features as described above, the present invention can provide a CHA zeolite having a micropore volume of 0.2-0.3 cm²/g: preferably, 0.22-0.28 cm²/g: or more preferably, 0.23-0.26 cm²/g.

Preferably, the CHA zeolite has a crystallinity of greater than 90%, e.g. greater than 95% or greater than 98%. The CHA zeolite can be substantially free of other crystalline phases and typically it is not an intergrowth of two or more framework types. As used herein, the term “substantially free” means that the zeolite contains less than about 10, 8, 6, 4, 2, or 1 weight percent of the named framework impurity or of all the impurities.

Preferably, the CHA zeolite has a granular particle. That is, it is preferred that the zeolite has a particulate morphology whereby the zeolite crystals have a three dimensional shape in contrast to rod like particles having a substantially one dimensional shape or disk or plate like particles having a two dimensional shape. It is preferred that the zeolite has a granular particle comprising or consisting of cubic crystals.

It is preferred that the CHA zeolite comprises uniform and non-aggregated cuboid crystals and/or uniform and non-aggregated conglomerate crystals. Conglomerate crystals are individual crystals that are tightly bound to each other to form relatively uniform particles, i.e. are not single or individual crystals. Conglomerate crystals can include twinned crystals.

Preferably, the CHA zeolite has an average crystal size (e.g. a mean longest edge crystal size) of no greater than 15 microns, preferably, no greater than 12 or 10 microns. In some embodiments, the CHA zeolite can have an average crystal size (e.g. a mean longest edge crystal size) of 0.25 to 15 microns, preferably 0.5 to 13, 1 to 12, 1.5 to 11 microns, 2 to 10 microns, 3 to 9.5 microns, 4 to 9 microns or 5 to 8 microns. In some embodiments, the average crystal size can be from 0.25 to 5 microns, from 0.3 to 4 microns, from 0.5 to 3 microns, from 0.6 to 2 microns, from 0.7 to 1.5 microns or from 0.75 to 1 micron. Such an average crystal size may be determined using standard microscopic techniques such as scanning electron microscopy (SEM). The measurement is taken over a statistically meaningful portion of the zeolites produced.

In a further aspect of the present invention, there is provided a method for the manufacture of a chabazite (CHA) zeolite having an SAR of from 8 to 35, the method comprising:
(i) forming a reaction gel comprising a precursor zeolite, an organic structure directing agent (OSDA), sodium and/or potassium hydroxide and optionally a silica source, and
(ii) heating the reaction gel to a temperature and for a duration suitable for the growth of the CHA zeolite.

It is particularly preferred that the method described herein is for making the H-form CHA zeolite described herein.

The method of the invention for making a CHA zeolite described herein is an inter-zeolite conversion (IZC) route.

The precursor zeolite can be selected from ferrierite (FER), faujasite (FAU), MFI, BEA and LTL. These zeolite frameworks are all known from the prior art (e.g. see for example WO2019242618, which discloses FER, BEA and MFI frameworks and WO2021101947 which discloses LTL frameworks). Preferably, the precursor zeolite is FER. The precursor zeolite may have a SAR value of from 2 to 30, such as from 10 to 20. In one embodiment the precursor zeolite has a SAR value of from 16 to 20 or 17 to 19. In another embodiment the precursor zeolite has a SAR value of from 12 to 16. In a specific embodiment the precursor zeolite is FER and has a SAR value of 2 to 30, 10 to 20, 12 to 20, 16 to 19 or 17 to 20, such as 16, 17, 18 or 19.

The precursor zeolite can have any counterion. For example, the counterion can be sodium, lithium, caesium, proton (H⁺), ammonium or organic cations. In a preferred embodiment, the counterion is a sodium counterion.

In one embodiment, the precursor zeolite is prepared from an organic structure directing agent (OSDA)-free reaction gel. In an alternative embodiment, ferrierite is prepared from a reaction gel which contains a structure directing agent, preferably an organic structure directing agent (OSDA).

The applicant has surprisingly found that the precursor zeolite does not need to be prepared using an organic structure directing agent (OSDA). This makes the method more efficient and reduces its environmental impact. An OSDA would typically be removed by calcination to prevent impurities in the final product: this energy intensive step is no longer required. This enables the precursor zeolite to be prepared at a much lower cost than precursors which require the use of an OSDA. Furthermore, the precursor zeolite formed without using an OSDA has been found to have comparable and even better properties to the precursors formed using an OSDA.

The precursor zeolite can be prepared by a process comprising:
(a) forming a reaction gel comprising an aluminium source, sodium and/or potassium hydroxide and a silica source,
(b) heating the reaction gel to a temperature and for a duration suitable for the growth of a FER zeolite, and optionally
(c) filtering and washing the resulting FER zeolite.

The method for preparing the precursor zeolite can comprise forming a reaction gel which may also simply be referred to as a reaction mixture. Such reaction gels are well known in the art of zeolite synthesis. The reaction gel for the method of preparing the precursor zeolite can comprise an aluminium source, sodium/potassium hydroxide and a silica source. Examples of aluminium sources include sodium aluminate, aluminum salts such as aluminum sulfate, aluminum nitrate, aluminum chloride, aluminum hydroxide, aluminum alkoxides, and alumina, preferably one or more of aluminum hydroxide and aluminum sulfate. Examples of silica sources include sodium silicate, potassium silicate, silica gel, silica sol, fumed silica, silicon alkoxides, and precipitated silica, preferably silica sol. Silica sol is a colloidal suspension of silica in water. In other preferred embodiments, the silica source and the aluminium source may comprise the same material, for example, silica-alumina or zeolites such as FER framework zeolites. In a preferred embodiment, the reaction gel comprises aluminium hydroxide, sodium hydroxide and silica sol solution.

In a further embodiment, the reaction gel for preparing the precursor zeolite can further comprise an OSDA. Examples of suitable OSDAs include N,N,N-trialkyl cyclohexylammonium derivates such as N,N,N-dimethylethylcyclohexylammonium; N,N,N-trialkyl benzylammonium derivates such as benzyltrimethylammonium; trialkyl (cyclohexylmethyl) ammonium derivates such as trimethyl(cyclohexylmethyl) ammonium; [NR₁R₂R₃R₄]+, and wherein R₁, R₂; R₃ and R₄ are independently an alkyl group having one to four carbon atoms, wherein the alkyl group can be optionally substituted by one or more hydroxyl groups, such as tetraethylammonium. In a further embodiment, the OSDAs are selected from a list comprising (e.g. consisting of): N,N,N-Trimethyl-1-adamantylammonium, N,N,N-dimethylethylcyclohexylammonium, trimethyl(cyclohexylmethyl) ammonium, and tetraethylammonium. In one embodiment, the reaction gel for preparing the precursor zeolite can further comprise an OSDA selected from a list comprising (e.g. consisting of): N,N,N-Trimethyl-1-adamantylammonium, N,N,N-dimethylethylcyclohexylammonium, trimethyl(cyclohexylmethyl) ammonium, and tetraethylammonium, benzyltrimethyl ammonium, N,N,N-triethylcyclohexyl ammonium, N,N,N-trimethylcyclohexyl ammonium, N,N,N-diethylmethylcyclohexyl ammonium, and triethylmethyl ammonium. In a further embodiment, the OSDA can be N,N,N-dimethylethylcyclohexylammonium, either used alone or in combination with a further OSDA (for example, N,N,N-Trimethyl-1-adamantylammonium and/or benzyl trimethylammonium). In a further embodiment, the OSDA can be benzyl trimethylammonium, either used alone or in combination with a further OSDA (for example, N,N,N-Trimethyl-1-adamantylammonium and/or N,N,N-dimethylethylcyclohexylammonium).

In a preferred embodiment, the reaction gel for preparing the precursor zeolite is an organic structure directing agent-free gel, i.e. the reaction gel does not comprise an ODSA. By “does not comprise an organic structure directing agent”, it is meant that the reaction gel for preparing the precursor zeolite comprises less than 1 wt % of an organic structure directing agent, e.g. less than 0.9 wt %, less than 0.5 wt %, less than 0.3 wt %, less than 0.2 wt %, less than 0.1 wt % or less than 0.01 wt % of an organic structure directing agent, based on the total weight of the reaction gel. In a preferred embodiment, the reaction gel for preparing the precursor zeolite comprises 0 wt % of an organic structure directing agent.

Heating the reaction gel for the preparation of the precursor zeolite is performed at a temperature and for a duration suitable for the growth of a FER zeolite. Preferably, the temperature to which the reaction gel is heated for such a suitable duration is from 100° C. to 220° C.: more preferably from 110° C. to 210° C., 120° C. to 200° C., 130° C. to 190° C., or even 140° C. to 180° C. The duration for which the reaction gel is heated to a suitable temperature, is preferably at least 10 hours, more preferably, 20 hours to 5 days, 1 day to 4 days, e.g., 3 days. It is particularly preferred that the reaction gel is heated to these temperatures and held at these temperatures for these durations, e.g. for at least 10 hours at a temperature of from 100° C. to 220° C.

Preferably, the FER zeolite product resulting from heating the reaction gel for such a temperature and duration is recovered by typical vacuum filtration. Preferably, the filtered product is washed with demineralized (also known as deionized) water is used to remove residual mother liquor. Preferably, the zeolite product is washed until the filtrate conductivity is below 0.1 mS. Preferably, the filtered and washed product is then dried at temperatures of greater than 100° C., preferably about 120° C. The FER zeolite product can be filtered by vacuum filtration and washed with demineralized water.

In a further embodiment, the method for preparing the precursor zeolite can further comprise a step of loading one or more enhancing metals onto the FER zeolite formed in step (b) or step (c). These enhancing metals can be loaded onto the FER zeolite by incipient wetness, ion exchange, or during the preparation of a washcoat slurry.

Enhancing metals are non-framework metals. As used herein, a “non-framework metal” is a metal that resides within the molecular sieve pores and/or on at least a portion of the molecular sieve surface, preferably as an ionic species, does not include aluminum, and does not include atoms constituting the framework of the molecular sieve. Preferably, the presence of an enhancing metal(s) facilitates the treatment of exhaust gases, such as exhaust gas from a diesel engine, including processes such as NOₓ reduction, NH₃ oxidation, and NOₓ storage.

Enhancing metals include certain transition metals, such as copper (Cu), iron (Fe), manganese (Mn), nickel (Ni), molybdenum (Mo), and zinc (Zn), with copper and/or iron being preferred and copper being most preferred. Certain enhancing metals are precious metals, such as gold (Au) and silver (Ag), and also platinum group metals such as platinum (Pt), palladium (Pd), ruthenium (Ru), and rhodium (Rh). Additionally, enhancing metals can be one or more rare earth metals such as cerium (Ce), praseodymium (Pr), neodymium (Nd), europium (Eu), erbium (Er), gadolinium (Gd), ytterbium (Yb), and yttrium (Y). (Although yttrium can be described as a transition metal, it is referred to herein as a rare earth metal due to its lanthanide-like properties.) Preferred rare earth metals include yttrium and erbium.

In an alternative embodiment, the FER mixture (which comprises a FER zeolite product and the associated mother liquor) resulting from heating the reaction gel for such a temperature and duration in step (b) is used directly, i.e. the FER mixture formed from heating the reaction gel for such a temperature and duration is used directly without separation of the FER zeolite from the mother liquor. In other words, the FER zeolite product and associated mother liquor formed in step (b) can be used directly as a precursor zeolite in the method for the manufacture of a chabazite (CHA) zeolite, making the process more efficient.

In an alternative embodiment, the FER is produced by methods described in the art (e.g. the methods described in U.S. Pat. No. 4,650,654 and WO 2020/021054)

The method of the invention involves a first step of forming a reaction gel. The reaction gel of the first step comprises a precursor zeolite, an organic structure directing agent (OSDA), sodium and/or potassium hydroxide and optionally a silica source.

Synthesis of zeolite crystals typically involves use of an organic template (also referred to as a structure directing agent or SDA: similarly, SDA cations can be referred to as SDA⁺). During crystallization, alumina and silica co-join to form a crystalline structure around the OSDA. The reactants, reaction conditions, and the species of OSDA all impact which type or types of framework that are synthesized. When sufficient crystallization has occurred, the crystals are removed from the mother liquor and dried. After the crystals are separated from the mother liquor, the organic SDA is thermally degraded and removed from the crystalline structure, thus leaving a porous molecular sieve.

The organic structure directing agent (OSDA) can be selected from N,N,N-trialkyl cyclohexylammonium derivates such as N,N, N-dimethylethylcyclohexylammonium; N, N,N-trialkyl benzylammonium derivates such as benzyltrimethylammonium; trialkyl (cyclohexylmethyl) ammonium derivates such as trimethyl(cyclohexylmethyl) ammonium; [NR₁R₂R₃R₄]⁺, and wherein R₁, R₂; R₃ and R₄ are independently an alkyl group having one to four carbon atoms, wherein the alkyl group can be optionally substituted by one or more hydroxyl groups, such as tetraethylammonium. In a further embodiment, the OSDA is selected from a list comprising (e.g. consisting of): N,N,N-trimethyl-1-adamantylammonium, N,N, N-dimethylethylcyclohexylammonium, trimethyl(cyclohexylmethyl) ammonium, and tetraethylammonium. In a further embodiment, the OSDA can be N,N,N-dimethylethylcyclohexylammonium, either used alone or in combination with a further OSDA (for example, N,N,N-Trimethyl-1-adamantylammonium). A further preferred example of an OSDA cation for use in the method is N,N,N-trimethyladamantylammonium (TMAd⁺). An alternative preferred example of an OSDA cation is N,N,N-dimethylethylcyclohexylammonium (DMECHA⁺). OSDA cations are typically associated with anions which can be any anion that is not detrimental to the formation of the zeolite. Representative anions include elements from Group 17 of the Periodic Table (e.g., fluoride, chloride, bromide and iodide), hydroxide, acetate, sulfate, tetrafluoroborate, carboxylate, and the like. In some embodiments the OSDA anion is selected from hydroxide, halide, sulfate and/or carbonate. In a preferred embodiment, the anion is a hydroxide anion, i.e. the OSDA is in hydroxide form. In a further preferred embodiment, the OSDA is selected from TMAd+ and/or DMECHA+, more preferably from TMAdOH and/or DMECHAOH.

In a preferred embodiment, the OSDA is selected from one or more of the following: N,N,N-trimethyl-1-adamantylammonium, N,N,N-dimethylethylcyclohexylammonium, trimethyl(cyclohexylmethyl) ammonium, tetraethylammonium, benzyltrimethyl ammonium, N,N,N-triethylcyclohexylammonium, N,N,N-trimethylcyclohexyl ammonium, N,N,N-diethylmethylcyclohexyl ammonium and triethylmethyl ammonium. In an even more preferred embodiment, the OSDA is selected from one or more of the following: N,N,N-trimethyl-1-adamantylammonium, N,N,N-dimethylethylcyclohexylammonium, and benzyltrimethyl ammonium. For example, the OSDA can be N,N,N-trimethyl-1-adamantylammonium. The OSDA can be N,N,N-dimethylethylcyclohexylammonium. The OSDA can be benzyltrimethyl ammonium, preferably in combination with another OSDA (e.g. one selected from N,N,N-trimethyl-1-adamantylammonium, N,N,N-dimethylethylcyclohexylammonium, trimethyl(cyclohexylmethyl) ammonium, tetraethylammonium, benzyltrimethyl ammonium, N,N,N-triethylcyclohexylammonium, N,N,N-trimethylcyclohexyl ammonium, and N,N,N-diethylmethylcyclohexyl ammonium).

In a further embodiment, the OSDA can be N,N,N-dimethylethylcyclohexylammonium, either used alone or in combination with a further OSDA (for example, N,N,N-Trimethyl-1-adamantylammonium and/or benzyl trimethylammonium). In a further embodiment, the OSDA can be benzyl trimethylammonium, either used alone or in combination with a further OSDA (for example, N,N,N-Trimethyl-1-adamantylammonium and/or N,N,N-dimethylethylcyclohexylammonium).

The OSDA may comprise trimethyl(cyclohexylmethyl) ammonium, such as trimethyl (cyclohexylmethyl) ammonium hydroxide, halide, sulfate and/or carbonate.

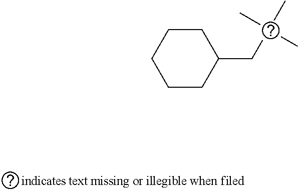

The OSDA may comprise N,N,N-Trimethyl-1-adamantanaminium, such as N,N,N-trimethyl-1-adamantanaminium hydroxide, halide, sulfate and/or carbonate.

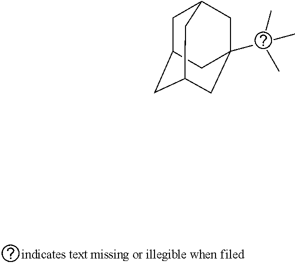

The OSDA may comprise trimethyl phenyl ammonium, such as trimethyl phenyl ammonium hydroxide, halide, sulfate and/or carbonate.

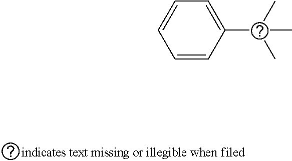

The OSDA may comprise N-ethyl-N,N-dimethylcyclohexanaminium, such as N-ethyl-N,N-dimethylcyclohexanaminium hydroxide, halide, sulfate and/or carbonate.

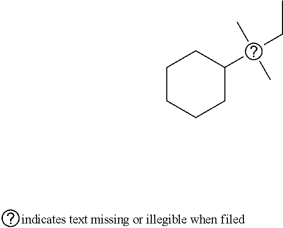

The OSDA may comprise trimethyl cyclohexyl ammonium, such as trimethyl cyclohexyl ammonium hydroxide, halide, sulfate and/or carbonate.

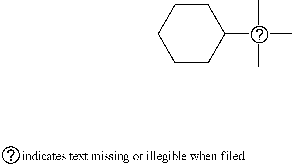

The OSDA may comprise benzyl trimethyl ammonium, such as benzyl trimethyl ammonium hydroxide, halide, sulfate and/or carbonate.

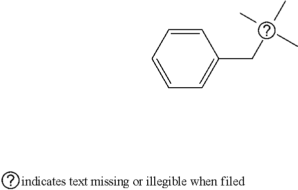

The OSDA may comprise tetraethyl ammonium, such as tetraethyl ammonium hydroxide, halide, sulfate or carbonate.

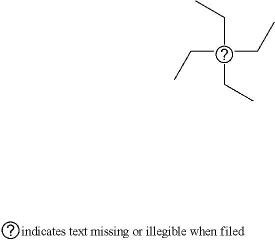

The reaction gel of the first step of the method of the invention is formed by the addition of one or both of sodium hydroxide and potassium hydroxide. Where only one of sodium and potassium hydroxide are used to form a reaction gel, sodium hydroxide is preferred.

The reaction gel of the first step of the method of the invention can further comprise a silica source. Preferably, the source of silica is one or more of sodium silicate, potassium silicate, silica gel, silica sol, fumed silica, silicon alkoxides, and precipitated silica, preferably silica sol. Silica sol is a colloidal suspension of silica in water.

In some embodiments, the reaction gel of the first step of the method does not comprise an additional alumina source.

As is known in the art, the reaction composition may be described in terms of the equivalent amount of SiO₂, Al₂O₃, M₂O (where M is Na and/or K), OSDA, and H₂O present in the reaction gel. In other words, the reaction gel composition may be described by the ratio: Al₂O₃:aSiO₂:bOSDA:cM₂O:dH₂O wherein the reaction composition is normalised to a molar amount (1 mole) of Al₂O₃ equivalent. As will be appreciated, the scale of the reaction and the absolute number of moles may vary.

In some embodiments, it is preferred that, relative to the molar amount of Al₂O₃ equivalent (i.e. 1 mole of Al₂O₃, which is provided by the alumina source, such as 2 moles of Al (OH);), the gel comprises from 0.1 to 4 moles of the OSDA. Preferably, relative to the molar amount of Al₂O₃ equivalent, the gel comprises from 0.2 to 2.5 moles of the OSDA, more preferably from 0.3 to 2 moles of the OSDA (i.e. “b” in the gel composition is from 0.1 to 4, preferably from 0.2 to 2.5, more preferably from 0.3 to 2).

In some embodiments, the M₂O equivalent, that is the total amount of Na₂O and K₂O equivalent (one or both may be present), relative to the molar amount of Al₂O₃ equivalent, is at least 1 mole, preferably from 1 to 25 moles, more preferably from 5 to 22 moles, more preferably from 6 to 20 moles. Equally, it may be said that “c” in the gel composition may be any of these ranges or values.

In some embodiments, it is preferred that, relative to the molar amount of Al₂O₃ equivalent, the gel comprises an amount of SiO₂ equivalent of at least 20 moles, preferably 20 to 60 moles, 20 to 55 moles, or 20 to 50 moles. Equally, it may be said that “a” in the gel composition may be any of these ranges or values. In some preferred embodiments, about 30 moles of SiO₂ equivalent are preferred.

In some embodiments, it is preferred that, relative to the molar amount of Al₂O₃ equivalent, the gel comprises water and the water is present in an amount of at least 700 moles, preferably 750 to 3000 moles. Equally, it may be said that “d” in the gel composition may be any of these ranges or values. For example, in some embodiments, higher amounts of water are preferred such as from 800 to 2600 moles, preferably from 900 to 2500 moles.

In some embodiments, it is preferred that the molar ratio of water to silica in the gel, i.e. the H₂O/SiO₂ molar ratio in the gel is from 25 to 50, preferably from 26 to 49, from 27 to 48.5, from 30 to 48, from 32 to 47 or from 33 to 46. In a preferred embodiment, the H₂O/SiO₂ molar ratio in the gel is from 26 to 49, 30 to 48, or from 32 to 47.

In some embodiments, it is preferred that the molar ratio of water to silica in the gel, i.e. the H₂O/SiO₂ molar ratio in the gel is from 2 to 50, preferably from 3 to 40, from 4 to 30, from 5 to 20, from 6 to 15 or from 7 to 12. In a preferred embodiment, the H₂O/SiO₂ molar ratio in the gel is from 5 to 15, 7 to 14, or from 8 to 10.

A particular advantage of the present method is that the inventors have found that the method does not require the use of seed crystals so as to form the desirable CHA zeolite. Accordingly, it is preferred that the reaction gel of the second step does not comprise seed crystals (i.e. CHA seed crystals).). By “does not comprise seed crystals”, it is meant that the reaction gel comprises less than 1 wt % seed crystals, e.g. less than 0.9 wt %, less than 0.5 wt %, less than 0.3 wt %, less than 0.2 wt %, less than 0.1 wt % or less than 0.01 wt % seed crystals, based on the total weight of the reaction gel. In a preferred embodiment, the reaction gel comprises 0 wt % seed crystals.

In one embodiment, the reaction gel of the second step does not comprise seed crystals, (i.e. the reaction gel comprises less than 1 wt % seed crystals, e.g. less than 0.9 wt %, less than 0.5 wt %, less than 0.3 wt %, less than 0.2 wt %, less than 0.1 wt % or less than 0.01 wt % seed crystals, based on the total weight of the reaction gel), and the OSDA is selected from a list comprising (e.g. consisting of): N,N,N-trimethyl-1-adamantylammonium, N,N,N-dimethylethylcyclohexylammonium, trimethyl(cyclohexylmethyl) ammonium, benzyltrimethyl ammonium, and tetraethylammonium.

In one particular preferred embodiment of the present invention, the reaction gel of the first step of the method of the invention consists of a precursor zeolite, an organic structure directing agent (OSDA), sodium and/or potassium hydroxide, a silica source, and water, and, optionally, a further sodium and/or potassium salt.

The method of the present invention further comprises a step of heating the reaction gel of the first step to a temperature and for a duration suitable for the growth of the CHA zeolite. Preferably, the temperature to which the reaction gel is heated for such a suitable duration is from 100° C. to 200° C.: more preferably from 110° C. to 190° C., 120° C. to 180° C., 120° C. to 170° C., or even 125° C. to 165° C. The duration for which the reaction gel is heated to a suitable temperature, is preferably at least 10 hours, more preferably, 20 to 60 hours. It is particularly preferred that the reaction gel is heated to these temperatures and held at these temperatures for these durations, e.g. for at least 10 hours at a temperature of from 100° C. to 200° C.

Preferably, the zeolite product resulting from heating the reaction gel for such a temperature and duration is recovered by typical vacuum filtration. Preferably, the filtered product is washed with demineralized (also known as deionized) water is used to remove residual mother liquor. Preferably, the zeolite product is washed until the filtrate conductivity is below 0.1 mS. Preferably, the filtered and washed product is then dried at temperatures of greater than 100° C., preferably about 120° C.

The CHA zeolite product synthesized by the present method may include one or more non-framework alkali and/or alkaline earth metals. These metals are typically introduced into the reaction mixture in conjunction with the source of hydroxide ions. Examples of such metals include sodium and/or potassium, and also magnesium, calcium, strontium, barium, lithium, cesium, and rubidium.

Usually it is desirable to remove the alkali metal cation by ion exchange and replace it with hydrogen, ammonium, or any desired metal ion. Accordingly, zeolites formed by the method of the present invention may be a Na-form zeolite, a K-form zeolite, or a combined N, K-form and the like, or may be an H-form zeolite, an ammonium-form zeolite, or a metal-exchanged zeolite. In a preferred embodiment, the CHA zeolite formed by the method of the present invention is a H-form zeolite.

Typical ion exchange techniques involve contacting the synthetic zeolite with a solution containing a salt of the desired replacing cation or cations. Although a wide variety of salts can be employed, chlorides and other halides, nitrates, sulfates and carbonates are particularly preferred.

Representative ion exchange techniques are widely known in the art. Ion exchange occurs post-synthesis and can take place either before or after the zeolite is calcined. Following contact with the salt solution of the desired replacing cation, the zeolite is typically washed with water and dried at temperatures ranging from 65° C. to about 315° C., usually between 80° C. and 150° C. After washing, the zeolite can be calcined in an inert gas and/or air at temperatures ranging from about 315° C. to 850° C. for periods of time ranging from 1 to 48 hours, or more, to produce a catalytically active and stable product.

In a further embodiment, the method for the manufacture of a chabazite (CHA) zeolite having an SAR of from 8 to 35, can further comprise a step of loading one or more enhancing metals onto the CHA zeolite formed in step (ii). These enhancing metals (i.e. enhancing metals as described herein) can be loaded onto the CHA zeolite by incipient wetness, ion exchange, or during the preparation of a washcoat slurry.

In a further aspect of the present invention, there is provided a catalyst article for the treatment of an exhaust gas, the catalyst article comprising the CHA zeolite as described herein.

In yet a further aspect, there is provided a method for the treatment of an exhaust gas, the method comprising contacting an exhaust gas with the catalyst article described herein.

In a further aspect of the invention, there is provided a hydrogen-form chabazite zeolite having a SAR of from 8 to 35 formed by the method as described herein.

### EXAMPLES

### General Procedure:

Synthesis gel mixture is prepared by blending the selected raw materials at room temperature according to the synthesis gel composition. The resulting fluid mixture is then transferred into and sealed in an agitated reactor. In crystallization step, the synthesis gel is crystallized via hydrothermal treatment. The crystallization temperature is 120° C. to 165° C. depending on the gel composition. Crystallization is carried out with continuously mixing the synthesis gel by agitation. The amount of time for crystallization is from 10 hours to less than 100 hours.

After crystallization, the resulting zeolite product is recovered by typical vacuum filtration. In the washing step, demineralized water is used to remove residual mother liquor from solid product until the filtrate conductivity is below 0.1 mS. In the drying step, the moisture water of the filtered solid product is removed by drying overnight in a 120° C. oven.

### Synthesis of FER—Example 1: Preparation of FER from OSDA-Free Synthesis Gel

First, 14.07 g of aluminum hydroxide (55.8 wt % Al₂O₃) was dissolved in the mixture of 32.84 g of sodium hydroxide solution (50.0 wt %) and 1221.8 g of demineralized under agitation at room temperature. Next, to the resulting clear solution, 231.3 g of silica sol solution (40.0 wt % SiO₂) was added and continuously agitation stirred for 30 minutes. The molar composition of the resultant gel was 20.0SiO₂-1.00Al₂O₃-2.67Na₂O-1000.0H₂O. The prepared initial gel was transferred to an autoclave for crystallization under agitation at 180° C. for 3 days. The crystallized solid product was filtered and washed with demineralized water, and dried overnight at 120° C. The XRD and XRF measurements showed that a zeolite with FER framework structure and SAR of 17.1 was obtained.

### Synthesis of FER—Example 2: Preparation of FER from OSDA-Free Synthesis Gel

First, 11.27 g of aluminum hydroxide (55.8 wt % Al₂O₃) was dissolved in the mixture of 32.88 g of sodium hydroxide solution (50.0 wt %) and 1224.4 g of demineralized water under agitation at room temperature. Next, to the resulting clear solution, 231.5 g of silica sol solution (40.0 wt % SiO₂) was added and continuously agitation stirred for 30 minutes. The molar composition of the resultant gel was 25.0SiO₂-1.00Al₂O₃-3.33Na₂O-1000.0H₂O. The prepared initial gel was transferred to an autoclave for crystallization under agitation at 180° C. for 3 days. The crystallized solid product was filtered and washed with demineralized water, and dried overnight at 120° C. The XRD and XRF measurements showed that a zeolite with FER framework structure and SAR of 19.7 was obtained.

### Synthesis of FER-Example 3: Preparation of FER from OSDA-Free Synthesis Gel

First, 47.5 g of sodium silicate solution (9.00 wt % Na₂O, 28.8 wt % SiO₂) was diluted with 723.5 g of demineralized water under agitation at room temperature. Separately, 11.34 g of sodium aluminate powder (52.7 wt % Al₂O₃) was dissolved in 351.0 g of demineralized water to form a clear solution under agitation at room temperature. Next, the latter solution was added to the former solution under vigorous agitation at room temperature and addition of 166.67 g silica sol solution (40.0 wt % SiO₂) to the mixture was followed. The resultant mixture was continuously stirred for 15 minutes, and the molar composition was 22.8SiO₂-1.00Al₂O₃-2.50Na₂O-1140.0H₂O. The prepared initial synthesis gel was transferred to an autoclave for crystallization under agitation at 180° C. for 4 days. The crystallized solid product was filtered and washed with demineralized water, and dried overnight at 120° C. The XRD and XRF measurements showed that a zeolite with FER framework structure and SAR of 19.0 was obtained.

### Synthesis of CHA—Example 1: Synthesis of CHA Using OSDA-Free FER as Aluminum Source and N,N,N-trimethyl-1-adamantammonium hydroxide (TMAdOH) as OSDA

1,700 g of initial synthesis gel was prepared by mixing the following ingredients: 109.0 g OSDA-free FER powder prepared according to Synthesis of FER-Example 1, 1,217.7 g of demineralized water, 13.91 g of sodium hydroxide solution (50.0 wt %), 136.04 g of TMAdOH solution (25.5 wt %), and 223.33 g of sodium silicate solution (28.8 wt % SiO₂, 9.00 Na₂O). The resulting mixture was agitated for 30 minutes, and its molar composition was 30.0SiO₂-1.00Al₂O₃-6.00Na₂O-2.00TMAdOH-1000.0H₂O. Then the gel was transferred to an autoclave for crystallization under agitation at 150° C. for 26 hours. The crystallized solid product was recovered by vacuum filtration, washing with demineralized water, and dried overnight at 120° C.

The activated H-form of the synthesized zeolite product was obtained by the following procedure. First the as-synthesized zeolite dry powder was calcined to burn off the OSDA species. A muffle furnace was used with a ramping rate of 1° C./min to 550° C. and held at 550° C. for six hours. The calcined product was then ammonium exchanged two times to remove sodium ions from the zeolite product. Ammonium sulfate was used, and the ion exchange took place at 80° C. for two hours. The solid product was recovered by filtration and washing. The filter cake was dried at 120° C. The resulting NH₄-form zeolite product was again calcined to convert to activated H-form zeolite product. This calcination was carried out using a muffle furnace with a ramping rate of 1° C./min to 550° C. and held at 550° C. for two hours.

The XRD, SEM and XRF measurements showed that a pure phase CHA with SAR of 19.3 was obtained. Table 1 listed the synthesis batch and resulting zeolite data.

### Synthesis of CHA—Example 2-8: Synthesis of CHA by Using OSDA-Free FER as Aluminum Source and N,N,N-trimethyl-1-adamantammonium hydroxide (TMAdOH) as OSDA

These synthesis examples required the same type of starting chemical agents and were carried out in a manner like that of Example 1. The specific gel compositions, crystallization conditions and the resulting activated product data are shown in or referred to Table 1 and 2. In Examples 2-7, the required OSDA-free FER was made according to Synthesis of FER-Example 1. In Example 8, the required as-made OSDA-free FER was made according to Synthesis of FER-Example 2.

### Synthesis of CHA—Example 9: Synthesis of CHA by Using a Pre-Crystallized OSDA-Free FER Batch as Aluminum Source and N,N,N-Trimethyl-1-Adamantammonium Hydroxide (TMAdOH) as OSDA

First, 357.3 g of synthesis gel for OSDA-free FER was prepared and crystallized according to Synthesis of FER-Example 2. Next, to this slurry which is essentially a mixture of OSDA-free FER and the mother liquor coming with the zeolite, the following additional ingredients were added under agitation: 6.16 g of sodium hydroxide solution (50.0 wt %), 24.34 g of TMAdOH solution (25.5 wt %), and 15.32 g of sodium silicate solution (28.8 wt % SiO₂, 9.00 Na₂O). The molar composition of the resulting mixture was 30.0SiO₂-1.00Al₂O₃-7.50Na₂O-2.00TMAdOH-1369.0H₂O. The gel was crystallized in an autoclave under agitation at 150° C. for 44 hours. The crystallized zeolite product was recovered and processed to activated form in the same manner that of Example 1.

The XRD, SEM and XRF measurements showed that a pure phase CHA with SAR of 17.6 was obtained. Table 1 and Table 2 also listed the synthesis batch and resulting zeolite data.

### Synthesis of CHA—Example 10-14: Synthesis of CHA by Using a Pre-Crystallized OSDA-Free FER Batch as Aluminum Source and N,N,N-Trimethyl-1-Adamantammonium Hydroxide (TMAdOH) as OSDA

These synthesis examples required the crystallized OSDA-free FER batch made according to Synthesis of FER-Example 1. Other required starting chemical agents were the same types as those of Example 9. The preparation of the CHA synthesis gel, crystallization, conversion of the as-made zeolite to the activated form product, and characterization were carried out in the same manner as those of Example 9, see Table 1 and 2.

### Synthesis of CHA—Example 15: Synthesis of CHA by Using OSDA-Free FER as Aluminum Source and a Mixture of N,N,N-Trimethyl-1-Adamantammonium Hydroxide (TMAdOH) and N-Ethyl, N,N-Dimethyl Cyclohexanaminium Hydroxide (R₂OH) as OSDA

These synthesis examples were carried out in the same manner as those of Example 1 except that N-ethyl, N,N-dimethyl cyclohexanaminium hydroxide (R₂OH) was also used along with TMAadOH as OSDA. The preparation of the CHA synthesis gel, crystallization, conversion of the as-made zeolite to the activated form product, and characterization were carried out in the same manner as those of Example 1, see Table 1 and 2.

### Synthesis of CHA—Example 16: Synthesis of CHA by Using a Pre-Crystallized OSDA-Free FER Batch as Aluminum Source and a Mixture of N,N,N-Trimethyl-1-Adamantammonium Hydroxide (TMAdOH) and N-Ethyl,N,N-Dimethyl Cyclohexanaminium Hydroxide (R₂OH) as OSDA

These synthesis examples were carried out in the same manner as those of Example 9 except that N-ethyl, N,N-dimethyl cyclohexanaminium hydroxide (R₂OH) was also used along with TMAadOH as OSDA. The preparation of the CHA synthesis gel, crystallization, conversion of the as-made zeolite to the activated form product, and characterization were carried out in the same manner as those of Example 9, see Table 1 and 2.

### Synthesis of CHA—Example 17: Synthesis of CHA by Using USY as Aluminum Source and N,N,N-trimethyl-1-adamantammonium hydroxide (TMAdOH) as OSDA

403.2 g of initial synthesis gel was prepared by mixing the following ingredients: 12.4 g of USY (SAR 11.26, Na₂O 0.15%), 304.8 g of demineralized water, 4.16 g of sodium hydroxide solution (50.0 wt %), 24.4 g of TMAdOH solution (25.5 wt %), and 57.4 g of sodium silicate solution (28.8 wt % SiO₂, 9.00 Na₂O). The resulting mixture was agitated for 30 minutes, and its molar composition was 30.0SiO₂-1.00A1203-7.47Na₂O-2.00TMAdOH-1369.0H₂O. The crystallization of this gel, conversion of the as-made zeolite to the activated form product, and characterization were carried out in the same manner as those of Example 1, see Table 1 and 2.

### Synthesis of CHA—Example 18: Synthesis of CHA by Using USY as Aluminum Source and a Mixture of N,N,N-Trimethyl-1-Adamantammonium Hydroxide (TMAdOH) and N-Ethyl, N,N-Dimethyl Cyclohexanaminium Hydroxide (R₂OH) as OSDA

1500.0 g of initial synthesis gel was prepared by mixing the following ingredients: 26.1 g of USY (SAR 11.26, Na₂O 0.15%), 1130.2 g of demineralized water, 13.9 g of sodium hydroxide solution (50.0 wt %), 45.0 g of TMAdOH solution (25.5 wt %), 17.5 g of R₂OH solution (53.6%) and 267.3 g of sodium silicate solution (28.8 wt % SiO₂, 9.00 Na₂O). The resulting mixture was agitated for 30 minutes, and its molar composition was 52.8SiO₂-1.00A1203-15.43Na₂O-1.76TMAdOH-1.76R₂OH-2428.2H₂O. The crystallization of this gel, conversion of the as-made zeolite to the activated form product, and characterization were carried out in the same manner as those of Example 1, see Table 1 and 2.

### Synthesis of CHA—Example 19: Synthesis of CHA by Using USY as Aluminum Source and a Mixture of N,N,N-Trimethyl-1-Adamantammonium Hydroxide (TMAdOH) and N-Ethyl,N,N-Dimethyl Cyclohexanaminium Hydroxide (R₂OH) as OSDA

420.0 g of initial synthesis gel was prepared by mixing the following ingredients: 21.6 g of USY (SAR 34.0, Na₂O 0.00%), 333.5 g of demineralized water, 13.44 g of sodium hydroxide solution (50.0 wt %), 12.60 g of TMAdOH solution (25.5 wt %), 4.91 g of R₂OH solution (53.6%) and 33.88 g of sodium silicate solution (28.8 wt % SiO₂, 9.00 Na₂O). The resulting mixture was agitated for 30 minutes, and its molar composition was 52.8SiO₂-1.00A1203-15.43Na₂O-1.76TMAdOH-1.76R₂OH-2428.2H₂O. The crystallization of this gel, conversion of the as-made zeolite to the activated form product, and characterization were carried out in the same manner as those of Example 1, see Table 1 and 2.

### Synthesis of CHA—Example 20: Synthesis of CHA by Using Na-Form OSDA-Free FER Batch as Aluminum Source and N-Ethyl,N,N-Dimethyl Cyclohexanaminium Hydroxide (R₂OH) as OSDA

180.0 g of initial synthesis gel was prepared by mixing the following ingredients: 36.07 g OSDA-free FER powder prepared according to Synthesis of FER-Example 3, 67.2 g of demineralized water, 1.02 g of sodium hydroxide solution (50.0 wt %), 17.30 g of N-ethyl,N,N-dimethyl cyclohexanaminium hydroxide solution (53.6 wt %), and 58.4 g of sodium silicate solution (28.8 wt % SiO₂, 9.00 Na₂O). The resulting mixture was agitated for 30 minutes, and its molar composition was 30.0SiO₂-1.00Al₂O₃-4.70Na₂O-2.10R₂OH-250.0H₂O. Then the gel was transferred to an autoclave for crystallization under agitation at 150° C. for 92 hours. The crystallized zeolite product was recovered and processed to activated form in the same manner that of Example 1. The XRD, SEM and XRF measurements showed that a pure phase CHA with SAR of 20.4 was obtained. Table 1 and Table 2 also listed the synthesis batch and resulting zeolite data.

### Synthesis of CHA—Comparative Example A: Synthesis of CHA by Using Precipitated Amorphous Aluminosilicate Cake as Aluminum Source and N,N,N-Trimethyl-1-Adamantammonium Hydroxide (TMAdOH) as OSDA

First, an amorphous aluminosilicate wet cake was prepared by blending a sodium silicate solution (28.8 wt % SiO₂, 9.00 Na₂O) solution and a solution made by mixing 25% sulfuric acid solution and an aluminum sulfate solution at 80° C. The resulting mixture was agitated for 30 min, then filtered and thoroughly washed with demineralized water. Next, 127.4 g of thus prepared amorphous aluminosilicate cake (SAR 30.6) was used to make 440.0 g of synthesis gel for CHA by mixing with other ingredients including 259.0 g of demineralized water, 18.6 g of sodium hydroxide solution (50.0 wt %), and 35.0 g of TMAdOH solution (25.5 wt %). The resulting gel was agitated for 30 minutes, and its molar composition was 30.6SiO₂-1.00Al₂O₃-7.50Na₂O-2.00TMAdOH-1000.0H₂O. The crystallization of this gel, conversion of the as-made zeolite to the activated form product, and characterization were carried out in the same manner as those of Example 1, see Table 1 and 2.

### Synthesis of CHA—Comparative Example B: Synthesis of CHA by Using Precipitated Amorphous Aluminosilicate Dry Powder as Aluminum Source and N,N,N-Trimethyl-1-Adamantammonium Hydroxide (TMAdOH) as OSDA

This synthesis example was the same as Comparative Example A except that the amorphous aluminosilicate cake was dried overnight at 120° C. and then used to make the CHA synthesis gel, see Table 1 and 2.

### Synthesis of CHA—Comparative Example C: Synthesis of CHA by Using Aluminum Nitrate as Aluminum Source and N,N,N-Trimethyl-1-Adamantammonium Hydroxide (TMAdOH) as OSDA

403.2 g of initial synthesis gel was prepared by mixing the following ingredients: a solution by dissolving 6.23 g of aluminum nitrate nonahydrate (98%) in 283.2 g of demineralized water, 20.6 g of sodium hydroxide solution (50.0 wt %), 23.90 g of TMAdOH solution (25.5 wt %), 15.32 g of sodium silicate solution (28.8 wt % SiO₂, 9.00 Na₂O) and 53.9 g of silica sol solution (40.0 wt % SiO₂). The resulting mixture was agitated for 30 minutes, and its molar composition was 52.8SiO₂-1.00Al₂O₃-15.43Na₂O-3.52TMAdOH-6.00NaNO₃-2428.2H₂O. The crystallization of this gel, conversion of the as-made zeolite to the activated form product, and characterization were carried out in the same manner as those of Example 1, see Table 1 and 2.

### Evaluation Example: Preparation of Catalyst and Performance Measurement for Selective Catalytic Reduction (SCR) of NOₓ

The activated products from Example #1 & #2 of Synthesis of CHA were loaded with 3.5 wt % Cu on anhydrous mass base of H-form CHA by incipient wetness impregnation using the required amount of copper (II) acetate dissolved in the pre-determined amount of demineralized water. The metal impregnated zeolite was dried overnight at 80° C. and then calcined in air at 550° C. for 4 hours. Each of calcined Cu-CHA was pelletized, crushed, and screened to collect the particles with size between 40 to 60 mesh. The thus prepared particle-form Cu—CHA was referred as fresh Cu—CHA sample. The following aging treatments of were applied for each fresh Cu—CHA: 650° C. for 100 hours in air flow with 10% H₂O by volume: 750° C. for 80 hours in air flow with 10% H₂O by volume: 800° C. for 16 hours in air flow with 10% H₂O by volume, and 900° C. for 5 hours in air flow with 5% H₂O by volume.

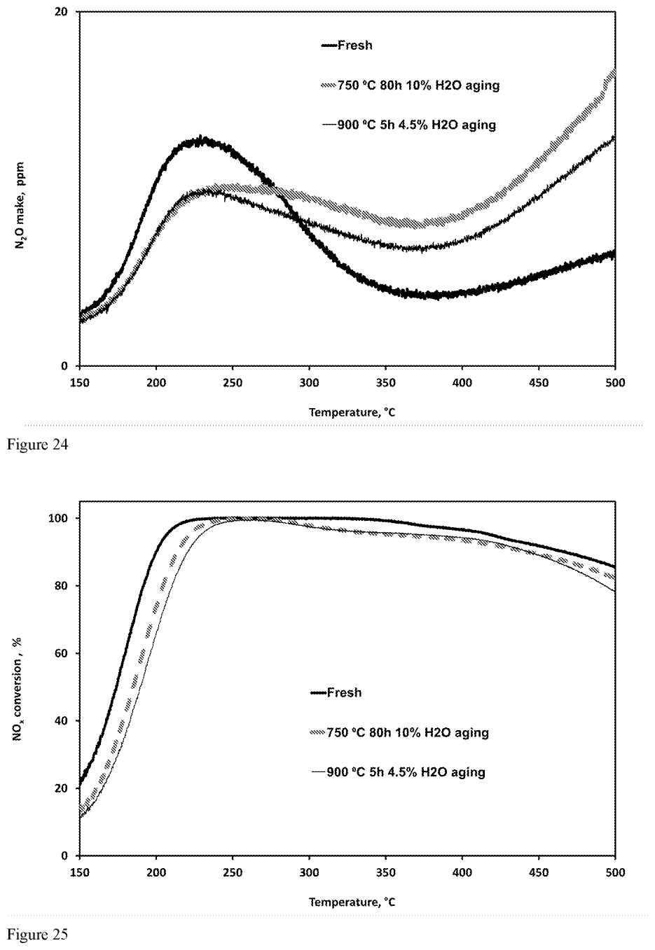

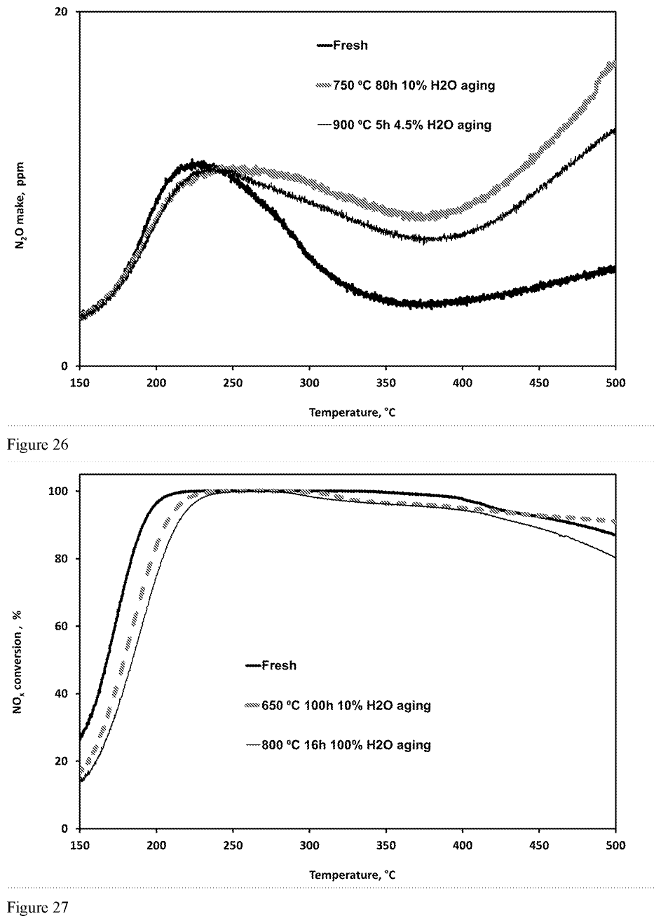

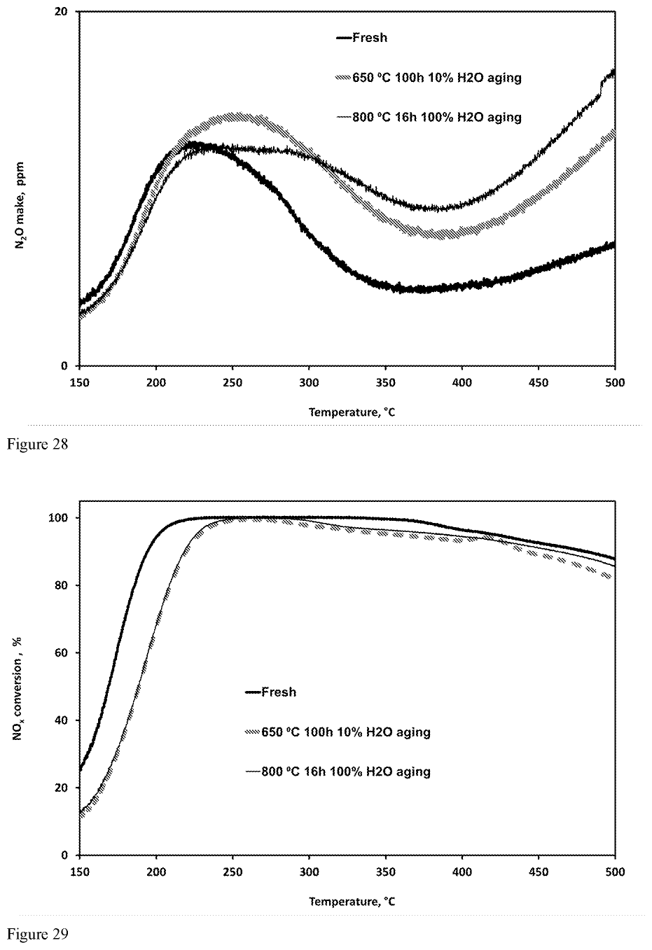

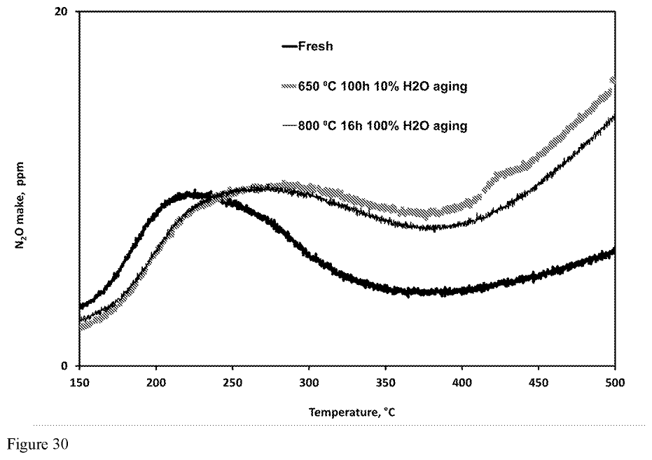

The fresh and aging-treated samples of each Cu—CHA catalyst were evaluated for NH₃—SCR of NOₓ. For comparison, two commercial CHAs, CHA1 (with a SAR of 18.5) and CHA2 (with a SAR of 12.8), were evaluated under the exact same conditions. The amount of each catalyst employed in the tests was 0.3 g. A gas flow comprising 500 ppm NO, 550 ppm NH₃, 350 ppm 10% H₂O and 10% O₂ was used. The flow rate of the gas flow employed was 2.6 L/min, equivalent to 520 L/hour per gram of catalyst. The sample was heated from room temperature to 150° C. under the above-mentioned gas mixture except for NH₃. At 150° C., NH₃ was added into the gas mixture and the sample was held under these conditions for 30 minutes. The temperature was then increased from 150° C. to 500° C. at a rate of 5° C./minute. The downstream gas treated by the catalyst was monitored to determine NOₓ conversion and N₂O selectivity, see FIGS. 23 to 30.

FIGS. 23 to 30 show that Example 1 is highly active in NO conversion under all testing conditions, with its overall performance being comparable to CHA1. Example 1 performed better at fresh and after mild (650° C., 100 h) and moderate ageing (750° C., 80 h) than CHA1, while CHA1 performed slightly better after moderately and highly severe ageing. Example 2 matches or performs slightly better in NO conversion than CHA2 under all testing conditions.

TABLE 1
List of gel composition and crystallization condition data for the synthesis examples and comparative synthesis examples for CHA

| CHA | Synthesis gel batch size and composition in molar | Al | |
|---|---|---|---|
| Synthesis | ratio to unit Al₂O₃ | source | Crystallization |
| #1 | 1700.0 g: 30.0SiO₂—6.00Na₂O—2.00TMAadOH—1000.0H₂O | FER, SAR 17.1 | 150° C./26 h |
| #2 | 300.0 g: 30.0SiO₂—7.50Na₂O—2.00TMAadOH—1000.0H₂O | FER, SAR 17.1 | 150° C./46 h |
| #3 | 403.2 g: 30.0SiO₂—7.47Na₂O—2.00TMAadOH—1369.0H₂O | FER, SAR 17.1 | 150° C./28 h |
| #4 | 400.0 g: 50.0SiO₂—12.0Na₂O—2.80TMAadOH—1300.0H₂O | FER, SAR 17.1 | 165° C./29 h |
| #5 | 400.0 g: 50.0SiO₂—15.0Na₂O—2.00TMAadOH—1300.0H₂O | FER, SAR 17.1 | 150° C./28 h |
| #6 | 400.0 g: 50.0SiO₂—18.0Na₂O—1.60TMAadOH—1300.0H₂O | FER, SAR 17.1 | 150° C./24 h |
| #7 | 450.0 g: 50.0SiO₂—20.0Na₂O—1.10TMAadOH—1300.0H₂O | FER, SAR 17.1 | 150° C./54 h |
| #8 | 403.2 g: 30.0SiO₂—7.47Na₂O—2.00TMAadOH—1369.0H₂O | FER, SAR 19.7 | 150° C./45 h |
| #9 | 403.2 g: 30.0SiO₂—7.50Na₂O—2.00TMAadOH—1369.0H₂O | FER + ML, | 150° C./44 h |
| | | SAR 19.7 | |
| #10 | 400.0 g: 50.0SiO₂—14.0Na₂O—2.00TMAadOH—1297.0H₂O | FER + ML, | 150° C./45 h |
| | | SAR 17.1 | |
| #11 | 430.0 g: 50.0SiO₂—14.7Na₂O—2.00TMAadOH—1300.7H₂O | FER + ML, | 150° C./26 h |
| | | SAR 17.1 | |
| #12 | 430.0 g: 50.0SiO₂—15.0Na₂O—2.00TMAadOH—1302.0H₂O | FER + ML, | 150° C./24 h |
| | | SAR 17.1 | |
| #13 | 400.0 g: 50.0SiO₂—18.0Na₂O—1.03TMAadOH—1300.0H₂O | FER + ML, | 150° C./29 h |
| | | SAR 17.1 | |
| #14 | 800.0 g: 52.8SiO₂—15.43Na₂O—3.52TMAadOH—2428.2H₂O | FER + ML, | 150° C./45 h |
| | | SAR 17.1 | |
| #15 | 403.2 g: 30.0SiO₂—7.47Na₂O—1.00TMAadOH—1.00R₂OH—1369.0H₂O | FER, SAR 17.1 | 150° C./48 h&175° C./24 h |
| #16 | 420.0 g: 52.8SiO₂—15.43Na₂O—1.76TMAadOH—1.76R₂OH—2428.2H₂O | FER + ML, | 150° C./24 h |
| | | SAR 17.1 | |
| #17 | 403.2 g: 30.0SiO₂—7.47Na₂O—2.00TMAadOH—1369.0H₂O | UB312, SAR | 150° C./23 h |
| | | 11.3 | |
| #18 | 1500.0 g: 52.8SiO₂—15.43Na₂O—1.76TMAadOH—1.76R₂OH—2428.2H₂O | USB312, SAR | 150° C./24 h |
| | | 11.3 | |
| #19 | 420.0 g: 52.8SiO₂—15.43Na₂O—1.76TMAadOH—1.76R₂OH—2428.2H₂O | CBV720, SAR | 150° C./50 h |
| | | 34.0 | |
| #20 | 180.0 g: 30.0SiO₂—1.00Al₂O₃—4.70Na₂O—2.10R₂OH—250.0H₂O | FER, SAR 19.0 | 150° C./92 h |
| #A | 440.0 g: 30.6SiO₂—7.50Na₂O—2.00TMAadOH—1000.0H₂O | AAS-C-cake, | 150° C./8d |
| | | SAR 30.6 | |
| #B | 400.0 g: 30.6SiO₂—7.50Na₂O—2.00TMAadOH—1000.0H₂O | AAS-A120, | 150° C./101 h |
| | | SAR 30.6 | |
| #C | 403.2 g: 52.8SiO₂—15.43Na₂O—3.52TMAadOH—6.00NaNO₃—2428.2H₂O | Al(NO3)₃ | 150° C./7d |

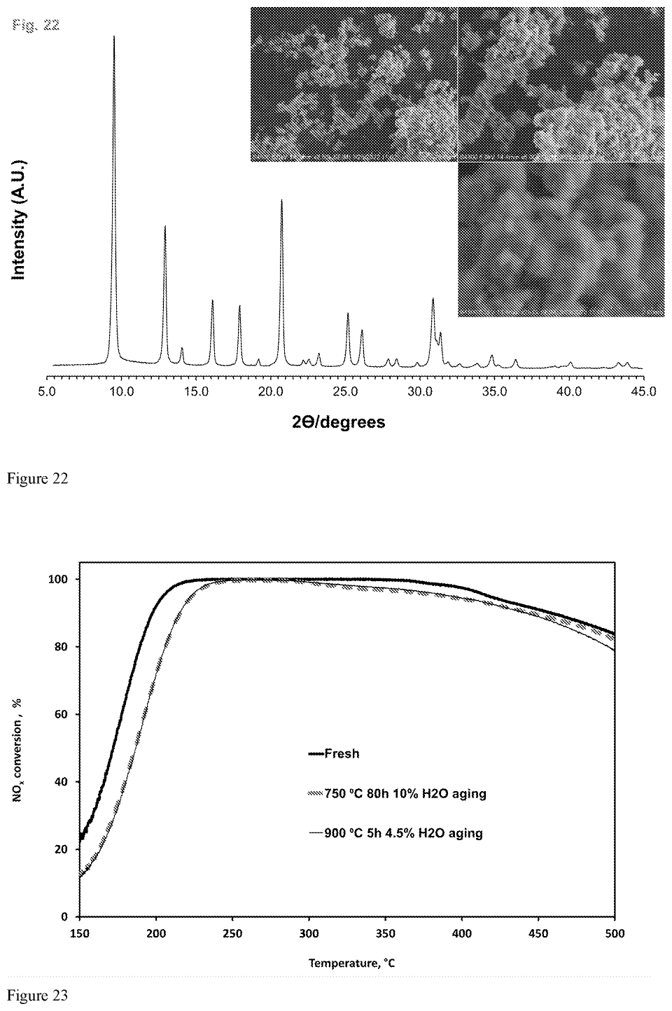

TABLE 2
List of characterization data for the activated CHA products

| | SAR | | |
|---|---|---|---|
| Activated | by | | |
| CHA | XRF | Crystalline phase(s) by XRD | Crystal morphology by SEM |
| #1 | 19.3 | CHA, XRD Pk INT > CHA1 (FIG. #1) | ~1.5 μm uniform cuboid and non-aggregated |
| | | | crystals (FIG. #1) |
| #2 | 16.9 | CHA, XRD Pk INT > CHA1 (FIG. #2) | ~10 μm uniform clusters of crystals (FIG. #2) |
| #3 | 16.9 | CHA, XRD Pk INT > CHA1 (FIG. #3) | ~4 μm uniform cuboid and non-aggregated |
| | | | crystals (FIG. #3) |
| #4 | 24.5 | CHA, XRD Pk INT > CHA1 (FIG. #4) | FIG. #4 |
| #5 | 18.1 | CHA, XRD Pk INT > CHA1 (FIG. #5) | ~3 μm uniform cuboid and non-aggregated |
| | | | crystals (FIG. #5) |
| #6 | 13.4 | CHA, XRD Pk INT > CHA2 (FIG. #6) | A mixture of ~7 μm uniform clusters of crystals |
| | | | and ~4 μm uniform cuboid and non-aggregated |
| | | | crystals (FIG. #6) |
| #7 | 10.1 | CHA, XRD PK INT > CHA2 (FIG. #7) | ~10 μm uniform and non-aggregated |
| | | | conglomerates of crystals (FIG. #7) |
| #8 | 17.6 | CHA, XRD Pk INT > CHA1 (FIG. #8) | A mixture of 4-10 μm clusters of crystals, ~4 |
| | | | μm uniform cuboid crystals, and thin sheet-like |
| | | | crystals (FIG. #8) |
| #9 | 17.8 | CHA, XRD Pk INT > CHA1 (FIG. #9) | A mixture of 10 μm clusters of crystals, ~7 μm |
| | | | uniform cuboid crystals (FIG. #9) |
| #10 | 22.2 | CHA, XRD PK INT > CHA1 (FIG. #10) | ~7 μm uniform cuboid and non-aggregated |
| | | | crystals (FIG. #10) |
| #11 | 19.5 | CHA, XRD Pk INT > CHA1 (FIG. #11) | ~3 μm uniform cuboid with all corners |
| | | | truncated and loosely aggregated crystals (FIG. |
| | | | #11) |
| #12 | 18.40 | CHA, XRD Pk INT > CHA2 (FIG. #12) | ~5 μm uniform cuboid with some corners |
| | | | truncated and non-aggregated crystals (FIG. #12) |
| #13 | 13.4 | CHA, XRD Pk INT > Ref CHA (FIG. #13) | A mixture of ~3 μm uniform cuboid and |
| | | | aggregated/conglomerated crystals (FIG. #13) |
| #14 | 22.3 | CHA, XRD Pk INT > CHA1 (FIG. #14) | FIG. #14 |
| #15 | 16.2 | CHA, XRD Pk INT > CHA1 (FIG. #15) | A mixture of twined, clustered, and uniform |
| | | | non-aggregated cuboid crystals, ~5 μm (FIG. |
| | | | #15) |
| #16 | 21.6 | CHA, XRD Pk INT > CHA1 (FIG. #16) | A mixture of twined, clustered, and uniform |
| | | | non-aggregated cuboid crystals, ~4 μm (FIG. |
| | | | #16) |
| #17 | 18.2 | CHA, XRD Pk INT < CHA1 (FIG. #17) | A mixture of clustered, and non-aggregated |
| | | | cuboid crystals, 0.2-0.4 μm (FIG. #17) |
| #18 | 23.0 | CHA, XRD Pk INT > CHA1 (FIG. #18) | 0.2-0.4 cuboid crystals (FIG. #18) |
| #19 | 21.7 | CHA, XRD Pk INT > CHA1 (FIG. #19) | 0.2-0.5 cuboid crystals (FIG. #19) |
| #20 | 20.4 | CHA, XRD PK INT > CHA1 (FIG. #19B) | 0.2-0.5 cuboid crystals (FIG. #19B) |
| #A | 17.3 | CHA, XRD PK INT ~ CHA1 (FIG. #20) | 0.2-1.0μm cuboid and aggregated crystals (FIG. |
| | | | 20) |
| #B | 18.0 | CHA, XRD Pk INT < CHA1 (FIG. #21) | 0.2-0.4 μm irregular shaped and clumped |
| | | | crystals (FIG. 21) |
| #C | 22.4 | CHA, XRD Pk INT < CHA1 (FIG. 22) | Irregular shaped and aggregated crystals (0.2- |
| | | | 0.6 μm ) (FIG. 22) |

1. A hydrogen-form chabazite (CHA) zeolite having a SAR of from 8 to 35 with a ratio of the XRD peak intensity corresponding to [2 1 1] and [−1 1 1] reflection equal to or greater than 0.80.

2. A hydrogen form CHA zeolite according to claim 1 having a SAR of from 8 to 17 with a ratio of the XRD peak intensity corresponding to [2 1 1] and [−1 1 1] reflection equal to or greater than 0.95.

3. A hydrogen form CHA zeolite according to claim 1 having a SAR of from 17 to 24 with a ratio of the XRD peak intensity corresponding to [2 1 1] and [−1 1 1] reflection equal to or greater than 0.85.

4. A hydrogen form CHA zeolite according to claim 1 having a SAR of from 24 to 34 with a ratio of the XRD peak intensity corresponding to [2 1 1] and [−1 1 1] reflection equal to or greater than 0.80.

5. The hydrogen-form CHA zeolite according to claim 1, wherein the CHA zeolite comprises uniform and non-aggregated cuboid crystals with an average size of from 1 to 10 pm.

6. The hydrogen-form CHA zeolite according to claim 1, wherein the CHA zeolite comprises uniform and non-aggregated conglomerate crystals.

7. The hydrogen-form CHA zeolite according to claim 1, wherein the CHA zeolite comprises a mixture of (a) uniform and non-aggregated cuboid crystals with an average size of from 1 to 10 pm and (b) uniform and non-aggregated conglomerate crystals.

8. The hydrogen-form CHA zeolite according to claim 1, wherein the zeolite has a crystallinity of greater than 90%.

9. A method for the manufacture of a chabazite (CHA) zeolite having an SAR of from 8 to 35, the method comprising:
(i) forming a reaction gel comprising a precursor zeolite, an organic structure directing agent (OSDA), sodium and/or potassium hydroxide and optionally a silica source, and
(ii) heating the reaction gel to a temperature and for a duration suitable for the growth of the CHA zeolite.

10. The method according to claim 9, wherein the precursor zeolite is selected from FER, FAU, MFI, BEA and LTL.

11. The method according to claim 9, wherein the precursor zeolite is prepared from an organic structure directing agent-free synthesis gel or prepared from a synthesis gel which contains an organic structure directing agent.

12. The method according to claim 9, wherein the precursor zeolite is prepared by a process comprising:
(a) forming a reaction gel comprising an aluminium source, sodium and/or potassium hydroxide and a silica source,
(b) heating the reaction gel to a temperature and for a duration suitable for the growth of a FER zeolite, and optionally
(c) filtering and washing the resulting FER zeolite.

13. The method according to claim 12, wherein the reaction gel does not comprise an OSDA.

14. The method according to claim 12, wherein the FER zeolite product and associated mother liquor formed in step (b) is used directly, without separation of the FER zeolite from the mother liquor.

15. The method according to claim 9, wherein the OSDA used in step (i) is selected from one of more of the following: N,N,N-trimethyl-1-adamantylammonium, N,N,N-dimethylethylcyclohexylammonium, trimethyl(cyclohexylmethyl) ammonium, tetraethylammonium, N-Ethyl-N,N-dimethylcyclohexanaminium, benzyltrimethyl ammonium, N,N,N-triethylcyclohexylammonium, N,N,N-trimethylcyclohexyl ammonium, N,N,N-diethylmethylcyclohexyl ammonium, trimethyl cyclohexyl ammonium, trimethyl phenyl ammonium and triethylmethyl ammonium.

16. The method according to claim 9, wherein the reaction gel of step (i) does not comprise CHA seed crystals.

17. The method according to claim 9, wherein the temperature of step (ii) is from 100° C. to 200° C., preferably from 110° C. to 190° C.

18. The method according to claim 9, wherein the duration of step (ii) is at least 10 hours, preferably 20 to 60 hours.

19. The method according to claim 9 for making a hydrogen-form chabazite (CHA) zeolite having a SAR of from 8 to 35 with a ratio of the XRD peak intensity corresponding to [2 1 1] and [−1 1] reflection equal to or greater than 0.80.

20. A catalyst article for the treatment of an exhaust gas, the catalyst article comprising a hydrogen-form chabazite (CHA) zeolite having a SAR of from 8 to 35 with a ratio of the XRD peak intensity corresponding to [2 1 1] and [−1 1 1] reflection equal to greater than 0.80, or obtainable by the method according to claim 9.

21. A method for the treatment of an exhaust gas, the method comprising contacting an exhaust gas with the catalyst article according to claim 20.

22. A hydrogen-form chabazite (CHA) zeolite having SAR of from 8 to 35 formed by the method of claim 9.
